(19) United States
(12) Patent Application Publication
(10) Pub. No.: US 2026/0340486 A1
(43) Pub. Date: Oct. 29, 2026

(54) MULTI-NODE AND NODE-SPECIFIC ARTIFICIAL INTELLIGENCE-BASED MODEL TRAINING

(71) Applicant: Dell Products L.P., Round Rock, TX (US)

(72) Inventors: Dora Boviz, Ottawa (CA); John Bradley Deforge, Chelsea (CA)

(21) Appl. No.: 19/190,282

(22) Filed: Apr. 25, 2025

(51) Int. Cl. G06N 20/00

(52) U.S. Cl. CPC G06N 20/00

(57) ABSTRACT

Multi-node and node-specific training of AI-based models utilized by distributed nodes (DNs) can be managed and performed. Central training node can train a model, based on first training data derived from information relating to respective conditions associated with and collected from respective DNs, to generate a trained model relating to the group of DNs such that the trained model can satisfy a first threshold performance level, wherein DNs can be RUs or DUs of a disaggregated RAN. Distributed training node (DTN) associated with DN can receive the trained model. DTN can train the trained model, based on second training data particularly relating to conditions of DN, to generate a refined trained model relating to particular conditions associated with DN such that the refined trained model can satisfy a second threshold performance level that is higher than first threshold performance level, particularly regarding AI-based output results for DN.

### BACKGROUND

Communication networks can enable users to use devices to wirelessly connect to a communication network and communicate with other devices (e.g., wireless devices or other communication devices). A device, such as a mobile device (e.g., smart phone or other mobile wireless device) can connect (e.g., wirelessly connect) to a cell (e.g., cell of a base station) or other access point associated with a radio access network (RAN) to facilitate connection to a communication network. Devices, via connection to the RAN and communication network, can utilize various types of services and applications of or associated with the communication network.

The above-described description is merely intended to provide a contextual overview regarding communication systems, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise receiving, by a system comprising at least one processor, a trained artificial intelligence (AI)-based model from a central node, wherein the trained AI-based model was trained based on first training data that can be determined based on a first group of data relating to a group of distributed nodes comprising at least a first distributed node and a second distributed node. The method also can comprise: based on second training data relating to conditions associated with the first distributed node, training, utilizing a distributed training node of the system, the trained AI-based model to generate a refined trained AI-based model that can be tailored to account for the conditions and characteristics associated with the first distributed node in connection with the refined trained AI-based model generating an inference.

In certain embodiments, the disclosed subject matter can comprise a system that can comprise at least one memory that can store computer executable components, and at least one processor that can execute computer executable components stored in the at least one memory. The computer executable components can comprise a distributed training node that can receive a trained AI-based model from a central node, wherein the trained AI-based model was trained based on first training information that can be determined based on a first group of information items relating to a cluster of distributed nodes comprising at least a first distributed node and a second distributed node. The computer executable components also can comprise a model trainer at the distributed training node, wherein the model trainer can train, based on second training information relating to conditions associated with the first distributed node, the trained AI-based model to generate a customized trained AI-based model that can be customized to take into account the conditions and attributes particular to the first distributed node in connection with generation of AI-based output information relating to the first distributed node by the customized trained AI-based model.

In still other embodiments, the disclosed subject matter can comprise a system that can comprise at least one memory that can store computer executable components, and at least one processor that can execute computer executable components stored in the at least one memory. The computer executable components can comprise a trainer node that can train an AI-based model, based on first training data applied to the AI-based model, to generate a trained AI-based model, wherein the first training data can be determined based on a first group of data relating to a group of distributed nodes comprising at least a first distributed node and a second distributed node. The computer executable components also can comprise a model repository that can store the trained AI-based model, wherein the trainer node or the model repository can communicate the trained AI-based model to a distributed training node associated with the first distributed node. The model repository can receive, from the distributed training node, an adapted trained AI-based model that can be adapted to take into account conditions and characteristics unique to the first distributed node in connection with generation of AI-based output data relating to the first distributed node by the adapted trained AI-based model, and wherein the trained AI-based model was trained, based on second training data relating to the conditions, to generate the adapted trained AI-based model.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably manage and perform multi-node training and distributed node-specific training of models, in accordance with various aspects and embodiments of the disclosed subject matter.

FIG. 2 depicts a block diagram of a non-limiting example system that can comprise a radio access network (RAN) that can comprise respective nodes that can facilitate desirably managing and performing multi-node training and distributed node-specific training of models, in accordance with various aspects and embodiments of the disclosed subject matter.

FIG. 3 depicts a block diagram of a non-limiting example central node, comprising a central training node that can perform multi-node training of AI-based models, in accordance with various aspects and embodiments of the disclosed subject matter.

FIG. 4 illustrates a block diagram of a non-limiting example system that can comprise a distributed node and a distributed training node that can perform node-specific training of a multi-node trained AI-based model for particular use by the distributed node, in accordance with various aspects and embodiments of the disclosed subject matter.

FIG. 5 depicts a diagram of a non-limiting example artificial intelligence (AI) component, in accordance with various aspects and embodiments of the disclosed subject matter.

FIG. 6 depicts a block diagram of non-limiting example system that can comprise the central node and the distributed training node(s) in the RAN in an open RAN (O-RAN) communication network environment to facilitate desirable management and performance of multi-stage training (e.g., multi-node and node-specific training) of AI-based models, in accordance with various aspects and embodiments of the disclosed subject matter.

FIG. 7 depicts a diagram of a non-limiting example base station that can desirably facilitate connections and communication of information associated with devices, in accordance with various aspects and embodiments of the disclosed subject matter.

FIG. 8 illustrates a diagram of a non-limiting example device that can be operable to engage in a system architecture that facilitates wireless communications according to one or more embodiments described herein, in accordance with various aspects and embodiments of the disclosed subject matter.

FIG. 9 illustrates a flow chart of an example method that can desirably manage and perform refined node-specific training of a trained AI-based model initially trained as part of multi-node model training, in accordance with various aspects and embodiments of the disclosed subject matter.

FIGS. 10-11 depict a flow chart of an example method that can desirably manage and perform multi-node and node-specific training of an AI-based model, in accordance with various aspects and embodiments of the disclosed subject matter.

FIG. 12 illustrates an example block diagram of an example computing environment in which the various embodiments of the embodiments described herein can be implemented.

FIG. 13 depicts a diagram of non-limiting example time series data of respective distributed nodes.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to systems, mechanisms, methods, and techniques that can manage and perform multi-node and node-specific artificial intelligence (AI)-based model training associated with a radio access network (RAN) of a communication network. Communication networks can enable users to use devices to wirelessly connect to a communication network and communicate with other devices (e.g., wireless devices or other communication devices). Communication networks also may employ AI-based technology to perform various tasks. For example, a communication network can employ an AI-based model to generate an inference or perform a task that can relate to operation of the communication network.

In some communication networks, there can be one or more RANs that each can comprise a group of distributed nodes that can perform various network-related functions. As an example, a distributed node can be a radio unit (RU) of a RAN (e.g., a disaggregated RAN). Existing techniques often can collect data relating to the distributed nodes and process such data centrally in the communication network.

For various types of applications, it can be desirable to utilize a model (e.g., an artificial intelligence (AI) or machine learning (ML) model) for inference and other desired purposes at the network edge of the communication network (or in other parts of the communication network). However, existing techniques can be deficient (e.g., inefficient, inaccurate, unsuitable, poor performing, suboptimal, or otherwise undesirable) in training AI or ML models and/or utilizing AI or ML models at the network edge of the communication network, and, accordingly, such AI or ML models can be deficient for use at the network edge of the communication network.

With further regard to the data associated with the distributed nodes, in networks with distributed nodes, while a relatively wide range of performance outcomes can be possible, each distributed node can be operating under different environmental and operational conditions. These conditions can determine a subset of overall potential performance outcomes at each node. Due to environmental and usage impacts, the behavior of components can evolve over time differently between different distributed nodes. Thus, data generated on each distributed node can, in some scenarios, differ from the data generated on other distributed nodes in the deployment. Accordingly, the data generated at each distributed node typically can differ between respective distributed nodes due in part to differences in data traffic load of the respective distributed nodes, differences in environmental conditions associated with respective distributed nodes, differences in configurations (e.g., node-specific hardware and/or software configurations) between the respective distributed nodes, and/or for other reasons. Different operational or environmental conditions can mean that it can be desirable to employ different optimization strategies. These different optimization strategies can be represented in distinct AI-based models. Data or datasets generated from each unique distributed node (e.g., each uniquely optimized distributed node) can exhibit statistically different characteristics from one another. Time series data generated by distributed nodes can be represented by a statistically unique segment of the data or dataset.

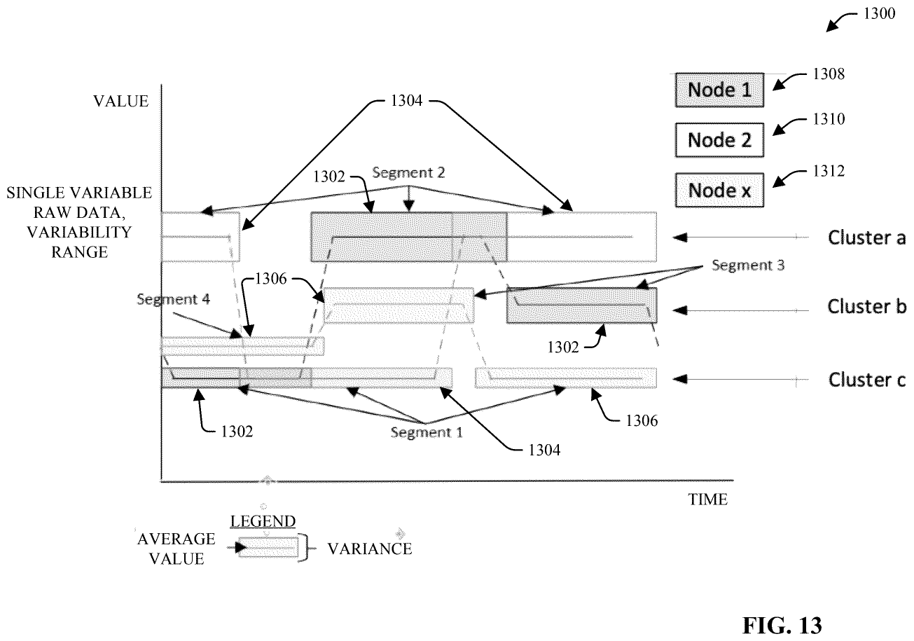

With further regard to time series data, the respective data collected from the respective distributed nodes can be time series data, wherein the time series data collected (e.g., centrally collected by the communication network) from each distributed node typically can be a succession of segments and can be based on respective (e.g., independent or unique) conditions experienced by each distributed node of a deployment. These data segments can be the same for all or a subset of distributed nodes, can have similar properties or characteristics, or can result from significantly different operational scenarios. As a result, the distributed nodes can be said to have data variability, such as can be illustrated in FIG. 13. FIG. 13 is a diagram of a non-limiting example time series data 1300 of respective distributed nodes, where there can be statistical characteristics of single-dimensional, single variable time series data with multiple data segments (although not limited to single-dimensional, single variable time series data). With regard to the data segments depicted in the time series data 1300, each of the time series data (e.g., time series data 1302, time series data 1304, and time series data 1306) can be generated in a different distributed node (e.g., node 1 1308, node 2 1310, and node x 1312, respectively). While for example purposes the time series data 1300 can be single dimensional and/or single variable time series data, time series data associated with distributed nodes also can be multi-dimensional and/or multi-variable time series data.

Collecting distributed data associated with the distributed nodes, bulk aggregating that data into a dataset, and creating a single AI or ML model for use in all distributed nodes, without accounting for the unique characteristics of each distributed node or specific segment, can lead to suboptimal performance of the model due to a deficient one-size-fits-all approach. Also, always using the same AI or ML model variant for each time series data and each distributed node can result in lower performance of the model due to the significant differences between data collected from different distributed nodes. It is noted that there may be instances where similar data segments can be present in data generated by different distributed nodes, where the same AI or ML model can be applicable though.

Further, it can be desirable to utilize AI-based models for inference execution and/or other AI-based analysis and output. In order to do so, it can be desirable to have AI-based models in each distributed node that can be suitable with respect to the locally observed conditions associated with that distributed node. To enable desirable (e.g., useful, enhanced, or optimal) use cases based on AI-based models with low latency specifications (e.g., requirements), the inference execution or other AI-based analysis potentially may be performed locally at the distributed nodes. However, due to practical product design of distributed nodes, the resources available at a distributed node for inference processing or other AI-based analysis can be undesirably limited. Therefore, it can be desirable for AI-based models to be sufficiently (e.g., highly) optimized in terms of resource usage. Such an approach can be said to be efficient where the AI-based models can be proportionally smaller with lower latency than a generic model applicable at all distributed nodes (e.g., where such an AI-based model can overcome the one-size-fits-all model inefficiencies). Unfortunately, existing systems, methods, and techniques for generating AI-based models can be deficient in generating AI-based models that can be desirable for the particularized use at a particular distributed node.

It can be desirable to address and overcome the aforementioned deficiencies and other deficiencies of existing systems and techniques for training and using AI or ML models. In that regard, the disclosed subject matter can provide enhanced techniques that can desirably (e.g., suitably, beneficially, advantageously, usefully, enhancedly, or optimally) address and overcome the aforementioned deficiencies and other deficiencies of the existing systems and techniques.

To that end, techniques that can desirably (e.g., automatically, dynamically, suitably, reliably, efficiently, enhancedly, and/or optimally) manage and perform multi-node training and node-specific training of models for use by distributed nodes, are presented. A system can comprise a communication network that can comprise a central node and one or more groups of distributed nodes that can be associated with the central node. In accordance with various embodiments, the communication network can comprise one or more RANs (e.g., a disaggregated RAN(s)), wherein the central node can be part of or associated with a central unit (CU) of a RAN or a core network associated with (e.g., communicatively connected to) the RAN and part of the communication network. In accordance with various embodiments, respective distributed nodes can be, or can be part of or associated with, respective radio units (RUs) or respective distributed units (DUs) of the RAN, for each of the one or more RANs. The respective distributed nodes also can comprise or can be associated with respective distributed training nodes that can be, or can be part of or associated with, the respective RUs or the respective DUs of the RAN, for each of the one or more RANs.

In some embodiments, with regard to the central node, the central node can comprise a central training node that, in response to a model training request from a model manager node, can train (e.g., can perform first stage, multi-node training of) an AI-based model, based at least in part on first training data (e.g., joint or multi-node training data) and a first group of parameters and/or hyperparameters, to generate a trained AI-based model relating to the group of distributed nodes such that the trained AI-based model can satisfy a first threshold performance level, wherein the first training data can be derived from information relating to respective conditions and/or respective characteristics associated with and collected from respective distributed nodes of the group of distributed nodes. In some embodiments, the trained AI-based model can be stored in a model repository of the central node.

In certain embodiments, in connection with a model training request, received from the model manager node, to perform second stage, node-specific training of the trained AI-based model, the distributed training node associated with the distributed node can receive the trained AI-based model from the model repository of the central node. In some embodiments, as part of or in connection the model training request, the distributed training node also can receive second training data (e.g., node-specific training data) and a second group of parameters and/or hyperparameters, wherein the second training data can be derived from information relating to respective conditions and/or respective characteristics associated with, particular or unique to, and collected from the distributed node. In certain embodiments, the distributed training node can train (e.g., can perform second stage, node-specific training of) the trained (e.g., multi-node trained) AI-based model, based at least in part on the second training data and the second group of parameters and/or hyperparameters, to generate a refined (e.g., adapted or customized) trained AI-based model relating to the particular conditions and characteristics associated with the distributed node such that the refined trained AI-based model can satisfy a second threshold performance level that can be higher than the first threshold performance level, particularly with regard to generation of AI-based output result data (e.g., inferences probabilities, and/or other AI-based output result data) for the distributed node, and such that the refined trained AI-based model can be tailored (e.g., customized or adapted) to account for the conditions and characteristics associated with the distributed node in connection with the refined trained AI-based model generating AI-based output result data. The refined trained AI-based model can be utilized by the distributed node (e.g., when the conditions and/or characteristics associated with the distributed node make the use of the refined trained AI-based model desirable) and/or can be stored in a local model library in a data store of the distributed node and/or can be stored in the model repository of the central node (e.g., for availability and use by the distributed node when desirable).

Similarly, other respective distributed training nodes associated with other respective distributed nodes can train the trained AI-based model (or another multi-node trained AI-based model), based at least in part on respective training data and respective groups of parameters and/or hyperparameters, to generate other respective refined trained AI-based models for use by the other respective distributed nodes. The other respective refined trained AI-based models also can be stored in respective local model libraries of the other respective distributed nodes and/or can be stored in the model repository of the central node (e.g., for availability and use by the other distributed nodes when desirable).

These and other aspects and embodiments of the disclosed subject matter will now be described with respect to the drawings.

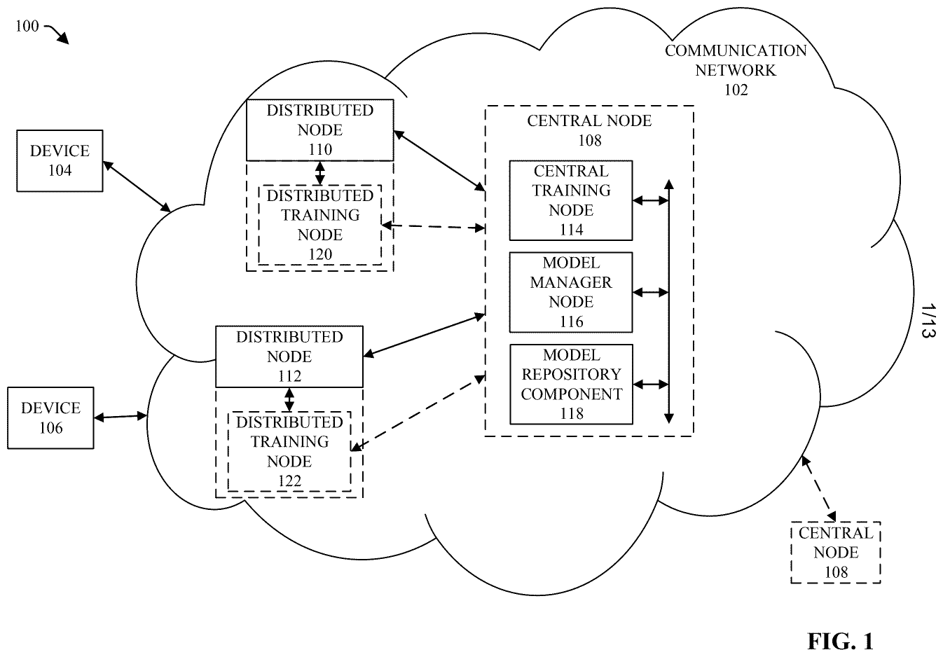

Referring now to the drawings, FIG. 1 illustrates a block diagram of a non-limiting example system 100 that can desirably (e.g., automatically, dynamically, suitably, reliably, efficiently, enhancedly, and/or optimally) manage and perform multi-node training and distributed node-specific training of models, in accordance with various aspects and embodiments of the disclosed subject matter. The system 100 can comprise a communication network 102 that can enable wireless and wireline communication of information between devices, such as device 104 and device 106, associated with (e.g., communicatively connected to) the communication network 102, and/or between the device (e.g., device 104) and the communication network 102. In some embodiments, the communication network 102 can comprise a core network and one or more RANs, associated with the core network, that can enable the wireless communication of information between the device (e.g., device 104) and the RAN and core network, such as described herein.

In certain embodiments, the communication network 102 can comprise a central node 108 and a group of distributed nodes, which can comprise one or more distributed nodes, such as distributed node 110 and/or distributed node 112, that can be associated with (e.g., communicatively connected to) the central node 108. In accordance with various embodiments, all or a portion of the central node 108 can be part of the core network and/or the RAN (e.g., the CU or other component of the RAN), such as described herein. In certain other embodiments, all or part of the central node 108 also may be located outside of the communication network 102 and communicatively connected to the communication network 102, and can be part of the AI/ML infrastructure that can serve the communication network 102. In accordance with various embodiments, all or a portion of the distributed node 110 can be part of an RU or a DU of the RAN, and/or all or a portion of the distributed node 112 can be part of an RU or a DU of the RAN, such as described herein. In some embodiments, all or some of the respective distributed nodes (e.g., 110 and 112) of the group of distributed nodes can be located (e.g., physically and/or logically located) at or near an edge (e.g., network edge) of the communication network 102. It is to be appreciated and understood that, while various aspects and embodiments described herein can relate to cellular and wireless networks and communications, in certain embodiments, the communication network 102 can be a communication network other than a cellular and/or wireless network, and the central node 108, the distributed nodes (e.g., 110 and/or 112), and/or other components of the system 100 can be employed in such communication network 102.

In accordance with various embodiments, the central node 108 can comprise a central training node 114, a model manager node 116, and a model repository 118. In some embodiments, the central training node 114, the model manager node 116, and the model repository 118 can be in the same central node 108. In certain other embodiments, the central training node 114, the model manager node 116, and/or the model repository 118 can be in separate central nodes that can be communicatively connected to each other, or can be part of separate portions of the central node 108, wherein the separate portions of the central node 108 can be communicatively connected to each other. In some embodiments, the central training node 114 (e.g., in conjunction with the model manager node 116) can perform multi-node training of a model (e.g., AI-based model), based at least in part on first training data (e.g., joint or multi-node training data), to generate a trained model relating to the group of distributed nodes (e.g., 110 and 112), wherein the first training data can be derived from information relating to respective conditions and/or respective characteristics associated with the respective distributed nodes (e.g., 110, 112) that can be received or collected (e.g., by the central node 108) from the respective distributed nodes (e.g., 110, 112) and/or other data sources. For instance, as part of a first stage of multi-stage model training, the central training node 114 can train (e.g., iteratively train) the model, based at least in part on the first training data, to generate the trained model (e.g., trained AI-based model) relating to conditions and/or characteristics associated with the group of distributed nodes (e.g., 110 and 112) such that the trained model can have a first performance level that can satisfy a first threshold performance level relating to generating AI-based output result data (e.g., inferences, probabilities, and/or other AI-based output result data), such as described herein. In certain embodiments, the central training node 114 can store the trained model in the model repository 118 (e.g., model catalog of the model repository 118 in a data store).

In accordance with various embodiments, the group of distributed nodes can comprise or can be associated with (e.g., communicatively connected to) a group of distributed training nodes that can train (e.g., further train, refine or adapt training of, and/or perform node-specific training of) trained models to generate refined trained models (e.g., refined trained AI-based models) that can be node-specific or particularized for the respective distributed nodes of the group of distributed nodes. In some embodiments, the group of distributed training nodes can comprise distributed training node 120 that can be part of, co-located with (e.g., physically co-located with), or associated with the distributed node 110, distributed training node 122 that can be part of, co-located with, or associated with the distributed node 112, and/or another distributed training node that can be part of, co-located with, or associated with another distributed node. In certain embodiments, one or more distributed training nodes can be instantiated for use in the system 100, as desired. In some embodiments, a distributed training node (e.g., 120 or 122) can share the same hardware and/or software resources with the associated distributed node (e.g., 110 or 112), and, in other embodiments, a distributed training node can alternatively or additionally comprise its owns hardware and/or software resources.

In some embodiments, the distributed node 110, the distributed training node 120, the distributed node 112, and the distributed training node 122 can be located at or near the network edge of communication network 102 (e.g., in relatively closer proximity to the respective devices (e.g., device 104 and/or device 106) than the central node 108), whereas the central node 108 can be more centrally located in the communication network 102 and relatively further away from the network edge. In certain embodiments, the respective refined trained models generated by the respective distributed training nodes (e.g., 120 and/or 122) also can be located at or near the network edge, and can be utilized by the respective distributed nodes (e.g., 110 and/or 112) at or near the network edge to desirably (e.g., suitably, efficiently, reliably, enhancedly, and/or optimally) perform AI-based analysis and provide AI-based output result data that can be utilized by the respective distributed nodes to perform various services, functions, and/or operations.

In certain embodiments, as part of a second stage of the multi-stage model training, the distributed training node 120 can train (e.g., iteratively train) the trained model, based at least in part on second training data (e.g., node-specific training data), to generate a refined (e.g., adapted) trained model relating to conditions and/or characteristics (e.g., particularized or unique conditions and/or characteristics) associated with the distributed node 110 such that the refined trained model can have a second performance level that can satisfy a second threshold performance level relating to generating AI-based output result data, and such that the refined trained model can be tailored (e.g., customized or adapted) to account for the conditions and characteristics associated with the distributed node 110 in connection with the refined trained model generating AI-based output result data, wherein the second threshold performance level can be higher than the first threshold performance level, and wherein the second performance level of the refined trained model can be higher than the first performance level of the trained model (e.g., multi-node trained model), such as described herein. The second training data can be derived or determined (e.g., by the central node 108, or, in other embodiments, by the distributed node 110 or the distributed training node 120) from information relating to the conditions and/or characteristics associated with the distributed node 110 that can be generated or collected by the distributed node 110 and/or obtained from other data sources. In certain embodiments, the refined trained model (e.g., performing at the higher second performance level) can provide enhanced (e.g., improved, optimized, or increased accuracy of) AI-based output data results with regard to the distributed node 110, as compared to other AI-based output data results that the trained model (e.g., performing at the lower first performance level) would be able to provide with regard to the distributed node 110.

In some embodiments, similarly, the distributed training node 122 can train the trained model, based at least in part on third training data, to generate a refined (e.g., adapted) trained model relating to conditions and/or characteristics associated with the distributed node 112 such that the refined trained model can have a second performance level that can satisfy the second threshold performance level.

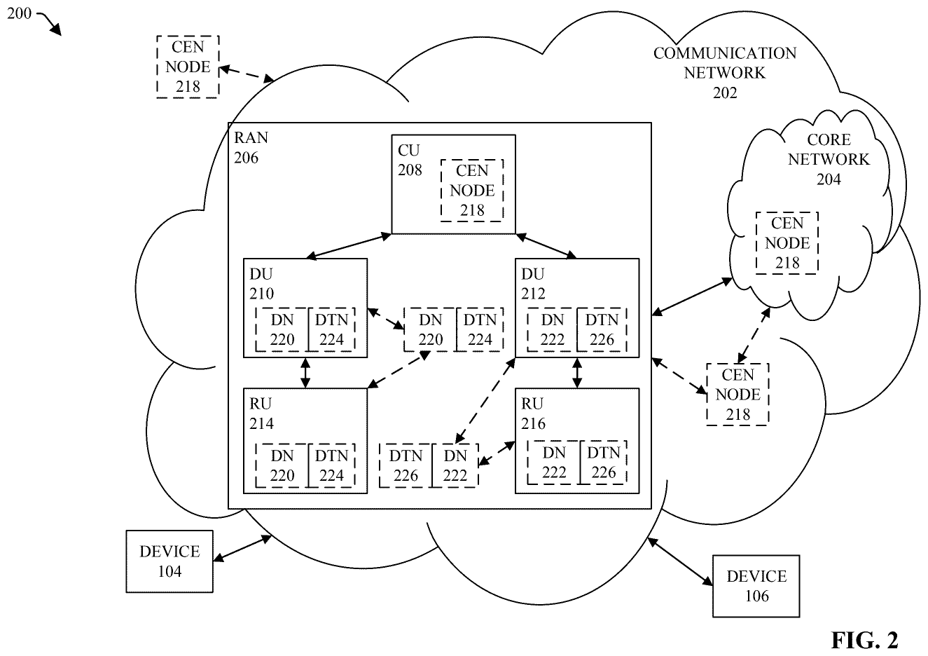

Referring to FIG. 2 (along with FIG. 1), FIG. 2 depicts a block diagram of a non-limiting example system 200 that can comprise a RAN (e.g., a disaggregated RAN) that can comprise respective nodes that can facilitate desirably (e.g., automatically, dynamically, suitably, reliably, efficiently, enhancedly, and/or optimally) managing and performing multi-node training and distributed node-specific training of models, in accordance with various aspects and embodiments of the disclosed subject matter. The system 200 can comprise a communication network 202 that can comprise a core network 204 and one or more RANs, such as RAN 206, that can be associated with (e.g., communicatively connected to) the core network 204. Each RAN (e.g., RAN 206) can comprise one or more base stations that each can comprise one or more cells (not shown in FIG. 2).

The core network 204, the one or more RANs (e.g., RAN 206), the one or more base stations, and the one or more cells can facilitate (e.g., enable) wireless communication of data (e.g., voice or other audio data, video data, textual data, or other data) between devices (e.g., communication devices or UEs), such as devices associated with the core network 204, via the one or more RANs, one or more base stations, and one or more cells, and other devices associated with the core network 204 or, more generally, the communication network 202 (e.g., a device, such as a server or computer, can be connected to the communication network 202 via a wireline connection or via a network other than the core network 204).

The devices can comprise, for example, devices 104 and/or 106. A device (e.g., 104 or 106) can be, for example, a wireless, mobile, or smart phone, a computer, a laptop computer, a server, an electronic pad or tablet, a virtual assistant (VA) device, electronic eyewear, an electronic watch, or other electronic bodywear, an electronic gaming device, an Internet of Things (IoT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device. In some embodiments, the non-limiting term UE can be used to describe the device. The device (e.g., 104 or 106) can be associated with (e.g., communicatively connected to) the communication network 202 via a communication connection and channel, which can include a wireless or wireline communication connection and channel.

In accordance with various embodiments, the core network 204 can comprise various network components that can facilitate wireless communication of data. In some embodiments, the RAN 206 can be a 5G or other RAN (e.g., gNB or xG RAN, wherein x can be a number greater than 5), and/or the base station(s) can be a 5G or other base station (e.g., gNB or xG base station, wherein x can be a number greater than 5). In some embodiments, the RAN 206 can be an open RAN (O-RAN) that can be part of an O-RAN architecture and environment (e.g., the communication network 202 can employ an O-RAN architecture and environment), such as described herein. In certain embodiments, the core network 204 can comprise a user plane function (UPF) (also can be referred to as a UPF node), an application function (AF) (also can be referred to as an AF node), an application server, an access and mobility management function (AMF), and/or other network functions (not shown in FIG. 2 for reasons of brevity and clarity). The UPF can connect to or interface with the one or more RANs (e.g., RAN 206) and the one or more base stations, can be an interconnect point between the core network 204 and a data network, can provide or facilitate providing a protocol data unit (PDU) session anchor point for providing mobility associated with radio access technologies (RATs), can provide or facilitate providing data packet routing or forwarding, and/or can perform or manage other functions.

The AF, which can be a control plane function, can be associated with, and can act as or fulfill all or part of the role of, the application server, and can interact and communicate with other network functions, including control plane functions, of the core network 204. The AF and associated application server can facilitate (e.g., enable) provision of various services (e.g., voice services, messaging services, media streaming services, Internet and intranet services, multimedia conferencing and collaboration services, or other services) and applications to devices associated with the core network 204. In some embodiments, some of the services can be low latency services and/or network edge services. The AF can comprise one or more AFs that respectively can be owned or managed by the network operator of the core network 204 or by third parties (e.g., trusted third parties). In some embodiments, the UPF can be associated with, and can interact and communicate with, the AF and/or other network functions (e.g., other control plane functions) via a service-based interface (SBI).

The AMF node can be a control plane function that can manage registration and deregistration of devices (e.g., devices 104 and/or 106) with the core network 204, manage connections of devices with the core network 204, manage mobility associated with devices (e.g., maintain knowledge of locations of devices, update locations of devices), and/or manage or perform other functions. In accordance with various other embodiments, the RAN(s) (e.g., RAN 206) and/or the base station(s) can comprise both 4^{th} generation (4G) long term evolution (LTE) technology and functions, and 5G or xG technology and functions.

The communication network 202, more generally, or the core network 204 can comprise various other network equipment (e.g., routers, gateways, transceivers, switches, access points, network functions, processor components, data stores, or other devices or network nodes) that facilitate (e.g., enable) communication of information between respective items of network equipment of the communication network 202, and/or communication of information between the one or more devices (e.g., devices 104 and/or 106) and the communication network 202. The communication network 202, including the core network 204, can provide or facilitate wireless or wireline communication connections and channels between the one or more devices (e.g., devices 104 and/or 106), and/or respectively associated services or applications, and the communication network 202. For reasons of brevity or clarity, some of the various network equipment, components, functions, or devices of the communication network may not be explicitly shown or described herein.

At various times, the respective devices (e.g., devices 104 and/or 106) can utilize respective services or applications. The services or applications can comprise or relate to, for example, voice service (e.g., conversational voice services or other voice services), video streaming service, conversational video service, buffered video service, audio streaming service, other type of streaming service, text or messaging service, data service, control message service (e.g., control message service relating to control of communication network functions and operations), signaling service, real time gaming service, interactive gaming service, transmission control protocol (TCP) service, control message service relating to automated or semi-automated vehicles or motorized devices, law enforcement-related service, medical-related service, emergency-related service, military-related service, background traffic service, or other desired types of service. In some embodiments, a service can be an extended reality (XR) service or other type of service that can involve or relate to communication of data bursts comprising PDU sets.

In some embodiments, the RAN 206 can be a disaggregated RAN that can comprise a CU 208, one or more DUs, such as DU 210 and/or DU 212, and one or more RUs, such as RU 214 and/or RU 216. The CU 208 can be associated with the one or more DUs (e.g., 210 and/or 212), and the one or more respective DUs can be associated with the one or more respective RUs (e.g., 214 and/or 216). In certain embodiments, the DU (e.g., 210 or 212) can be located in a first location (e.g., geographical, physical, and/or logical location), the CU 208 can be located in the first location or a second location, and the RU (e.g., 214 or 216) can be located in the first location, the second location, or a third location.

In accordance with various embodiments, all or respective portions of a central node (CEN NODE) 218 can be part of the core network 204, the CU 208, and/or another component (e.g., service management and orchestration (SMO) or RAN Intelligent Controller (RIC)) of the communication network 202 (e.g., the core network 204 can be or can comprise all or a portion of the central node 218, and/or the CU 208 can be or can comprise all or a portion of the central node 218), or the central node 218 can be a standalone component that can be associated with (e.g., communicatively connected to) the core network 204 and/or the CU 208. In accordance with various embodiments, all or respective portions of a distributed node (DN) 220 can be part of the RU 214, the DU 210, and/or another component of the communication network 202 (e.g., the RU 214 can be or can comprise all or a portion of the distributed node 220, and/or the DU 210 can be or can comprise all or a portion of the distributed node 220), or the distributed node 220 can be a standalone component that can be associated with the RU 214, the DU 210, the central node 218, and/or another component of the communication network 202. Similarly, in accordance with various embodiments, all or respective portions of a distributed node 222 can be part of the RU 216, the DU 212, and/or another component of the communication network 202 (e.g., the RU 216 can be or can comprise all or a portion of the distributed node 222, and/or the DU 212 can be or can comprise all or a portion of the distributed node 222), or the distributed node 222 can be a standalone component that can be associated with the RU 216, the DU 212, the central node 218, and/or another component of the communication network 202.

In accordance with various embodiments, all or respective portions of a distributed training node (DTN) 224 can be part of the distributed node 220, and/or the distributed training node 224 can be associated with (e.g., communicatively connected to) the distributed node 220. Similarly, in accordance with various embodiments, all or respective portions of a distributed training node 226 can be part of the distributed node 222, and/or the distributed training node 226 can be associated with (e.g., communicatively connected to) the distributed node 222.

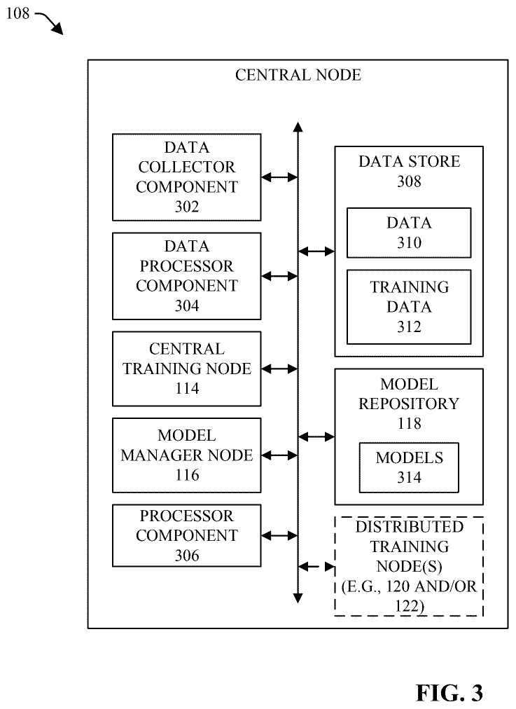

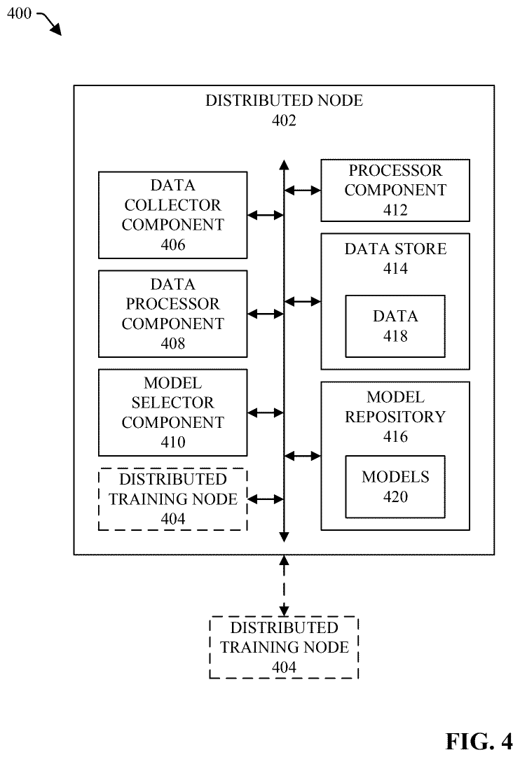

Referring to FIGS. 3 and 4 (along with FIGS. 1 and 2), FIG. 3 is a block diagram of non-limiting example central node 108, comprising the central training node 114 that can perform multi-node training of AI-based models, and FIG. 4 is a block diagram of a non-limiting example system 400, which can comprise a distributed node 402 and a distributed training node 404 that can perform node-specific training of a multi-node trained AI-based model for particular use by the distributed node 402, in accordance with various aspects and embodiments of the disclosed subject matter. In accordance with various embodiments, the central node 108 can comprise a data collector component 302, a data processor component 304, the central training node 114, the model manager node 116, a processor component 306, and a data store 308.

In some embodiments, the data store 308 can store various types of data relating to the central node 108, distributed nodes (e.g., distributed node 110 (or 402), distributed node 112), distributed training nodes (e.g., distributed training node 120 (or 404), distributed training node 122), devices (e.g., device 104, device 106), the core network 204, and/or the communication network 102. The various types of data stored in the data store 308 can comprise, for example, data 310, such as collected data (e.g., distributed node-related data relating to respective conditions and/or respective characteristics associated with respective distributed nodes), statistical data (e.g., statistical data that can be derived from and/or representative of the distributed node-related data associated with the distributed nodes), other processed or derived data, metadata (e.g., parameters, hyperparameters, and/or other metadata), and/or other type(s) of data, training data 312 that can be utilized for training (e.g., multi-node training) of AI-based models to generate trained AI-based models 314 (e.g., multi-node trained AI-based models and node-specific refined trained AI-based models), which can be stored in the model repository 118 of the central node 108 along with model-related information (e.g., respective parameters, respective hyperparameters, and/or other respective metadata associated with the respective trained AI-based models 314). In accordance with various embodiments, some of the metadata can comprise descriptor information that can describe or identify respective characteristics of a trained (e.g., multi-node trained) AI-based model and/or a refined trained AI-based model to facilitate distributed node-specific training of the trained AI-based model to generate the refined trained AI-based model, model selection to facilitate determining (e.g., by the model selector component) whether to select the refined trained AI-based model for use by the distributed node (e.g., distributed node 110 (or 402)), inference or other AI-based operations by the reference trained artificial intelligence-based model, and/or performance of other functions and/or operations, such as described herein.

The AI-based models stored in the model repository 118 can comprise the trained AI-based models (e.g., multi-node trained AI-based models) and/or refined (e.g., adapted) trained AI-based models (e.g., refined node-specific trained AI-based models), wherein the central node 108 can receive the refined trained AI-based models from the respective distributed training nodes (e.g., 120 (or 404), 122) for storage in the model repository 118. In some embodiments, the model repository 118 (e.g., a data store utilized as the model repository) can comprise nonvolatile memory and/or volatile memory usable for storage of data, such as described herein.

In certain embodiments, the distributed node 402 can be one distributed node of a group of distributed nodes that can be associated with the central node 108 in the communication network 102. For instance, the distributed node 402 can be the same as or similar to the distributed node 110 or distributed node 112, as depicted in FIG. 1. For clarity and brevity, only one distributed node 402 and one distributed training node 404 are illustrated in FIG. 4, and it is to be appreciated and understood that the group of distributed nodes can comprise virtually any desired number (e.g., 1, 2, 3, 4, 5, or other desired number greater than 5) of distributed nodes that can be associated with (e.g., communicatively connected to) the central node 108, and correspondingly, the respective distributed nodes of the group of distributed nodes can be associated with respective distributed training nodes, which also can be associated with the central node 108. In accordance with various embodiments, the distributed node 402 can comprise, for example, a data collector component 406, a data processor component 408 (e.g., a data processor that can analyze, filter, select, and/or otherwise process data), a model selector component 410, a processor component 412, a data store 414, and/or a model repository 416 (which also can be referred to as a local model repository of the distributed node 402). In some embodiments, the data store 414 various types of data relating to the distributed node 402, the distributed training node 404, devices (e.g., device 104 and/or device 106), the core network 204, and/or the communication network 102. The various types of data stored in the data store 414 can comprise, for example, data 418, such as collected data (e.g., distributed node-related data relating to conditions and/or characteristics associated with the distributed node 402), the statistical data relating to the distributed node 402 and/or other distributed nodes, other processed or derived data, metadata, and/or other type(s) of data, data relating to AI-based models, and/or other desired data. The local model repository 416 can be employed to store AI-based models 420, such as refined trained AI-based models that can be particularly trained for use by the distributed node 402, and model-related information (e.g., respective parameters, respective hyperparameters, and/or other respective metadata associated with the respective refined trained AI-based models 420) relating thereto. In certain embodiments, the model repository 416 can comprise nonvolatile memory and/or volatile memory usable for storage of data, such as described herein.

In accordance with various embodiments, the distributed node 402 can comprise the distributed training node 404 (or a portion thereof), or can be associated with (e.g., communicatively connected to) the distributed training node 404. In some embodiments, the distributed training node 404 can be in relatively close proximity (e.g., close physical and/or logical proximity) to the distributed node 402. Similarly, other respective distributed nodes of the distributed node group can comprise or can be in relatively close proximity to other respective distributed training nodes. In still other embodiments, if and as desired, a distributed training node can be associated with and can service more than one distributed node. In certain embodiments, such as when the distributed node 402 comprises the distributed training node 404, the data store 414 can comprise training data that can be utilized for training (e.g., node-specific or refined training) of trained AI-based models to generate refined trained AI-based models for use by the distributed node 402. In some embodiments, if the distributed training node 404 is separate from the distributed node 402, the distributed training node 404 can comprise its own data processor component, processor component, and data store, or can have access to a data processor component, processor component, and data store, to facilitate performance of operations by the distributed training node 404, such as described herein.

In still other embodiments, one or more respective distributed training nodes can be physically and/or logically located in the central node 108 and associated with (e.g., logically associated with) respective distributed nodes. As a non-limiting example, one or more respective distributed training nodes, such as the distributed training node 120 (or 404) and distributed training node 122, can be logical distributed training nodes that can be physically or deployment-wise within the central node 108, and can be mapped to respective distributed nodes, such as the distributed node 110 (or 402) and/or the distributed node 112.

In certain embodiments, the respective distributed nodes (e.g., 110 (or 402) and/or 112) can receive and/or collect respective condition-related information relating to respective conditions associated with the respective distributed nodes. For instance, the distributed node 402, employing the data collector component 406, can receive and/or collect condition-related information relating to the conditions associated with the distributed node 402, wherein the condition-related information can relate to respective conditions at respective times. The conditions can comprise, for example, operational conditions relating to operation of the distributed node (e.g., 110 (or 402) or 112), communication-related conditions associated with the distributed node, data traffic and processing load-related conditions, environmental conditions relating an environment associated with the distributed node, and/or other conditions associated with the distributed node or other network equipment or devices associated therewith. In some embodiments, the collected data (e.g., respective condition-related information and/or respective characteristics information) associated with respective distributed nodes can be or can comprise respective time series data (e.g., single dimensional and/or single variable time series data, and/or multi-dimensional and/or multi-variable time series data) comprising respective data segments, such as described herein.

The conditions can comprise or can relate to, for example, distortion, energy consumption, emissions, voltage bias (Vbias), component temperature, ambient temperature, transmission power (e.g., radio frequency (RF)_power (P) output (RF_Pout)), crest factor reduction (CFR) coefficients or parameters, digital predistortion (DPD) coefficients or parameters, and/or other conditions associated with the distributed node (e.g., 110 (or 402) or 112). The conditions also can relate to the time periods associated with such operational conditions, such as, for example, the time of day, day of week, month of year, or other time period.

The conditions also can comprise or can relate to, for example, signal-to-interference-plus-noise ratio (SINR), reference signal received power (RSRP), reference signal received quality (RSRQ), channel quality indicator (CQI), channel conditions, quality of service (QoS), perceived QoS, quality of experience (QoE) of a user, data traffic load, data processing load, throughput, latency, distortion, energy efficiency, and/or other desired conditions, metrics, or parameters that can indicate the features or qualities of conditions associated with the distributed node (e.g., 110 (or 402) or 112) and/or devices (e.g., 104 and/or 106) associated with the distributed node. In certain embodiments, the condition-related information also can comprise time data (e.g., timestamp or other time data that can indicate when a condition occurred or when an item of information relating to the condition was generated, event data (e.g., information relating to an event (e.g., sporting event, entertainment event, or other event where people using devices may gather) associated with a condition, such as an event that was taking place in proximity to the distributed node at the time the condition occurred), mapping data (e.g., mapping between a condition and another condition, mapping between a condition and a time of occurrence of the condition, mapping between a condition and an event, or other mapping relating to conditions), and/or other metadata relating to the conditions.

The conditions also can comprise or can relate to, for example, an environment associated with (e.g., in proximity to; or within a defined distance of) the distributed node (e.g., 110 (or 402) or 112). For instance, the conditions can relate to whether the distributed node is located in a relatively populated or congested area (e.g., a metropolitan area that can have a relatively higher and/or more dense population of people who can use various devices) or a more rural area (e.g., an area having a relatively lower and/or less dense population of people), whether the distributed node is located near a hill or other environmental barrier in one or more directions (e.g., distributed node located in proximity to or within a defined distance of a relatively large hill located to the north of the distributed node), whether the distributed node is located in a business district (e.g., an area where there is a significant number of businesses that may have a relatively large number of people using devices during the business day on weekdays, but a relatively lower number of people using devices during evening or nighttime hours and/or during weekends) or non-business district (e.g., a residential area), and/or whether the distributed node is located near a venue(s) (e.g., a sports venue, a concert venue, an entertainment venue, or other venue) where a relatively large number of people using devices may gather for events. The conditions also can relate to, for example, weather conditions (e.g., temperature, humidity, precipitation, air pressure, wind speed and direction, tornado, hurricane, flood, thunder, lightning, or other weather condition or event), climate conditions, electromagnetic interference, or other conditions that can have an effect on the operation of the distributed node.

In some embodiments, the respective distributed nodes (e.g., 110 (or 402) and/or 112) also can have and/or can collect respective characteristics-related information relating to respective characteristics (e.g., attributes, features, or properties) of or associated with the respective distributed nodes. For instance, the distributed node 402, employing the data collector component 406, can have and/or can collect characteristics-related information relating to the characteristics of or associated with the distributed node 402. The characteristics can relate to, for example, type(s) of cell(s) (e.g., sub-3 gigahertz (GHz) cell (e.g., sub-3 cell), and sub-6 GHz cell (e.g., sub-6 cell), millimeter wave (mmwave) cell, frequency division duplexing (FDD) cell, time division duplexing (TDD) cell, and/or other type of cell) of the distributed node, an accelerator function(s) (e.g., look-aside accelerator function, inline accelerator function, and/or other type of accelerator function) associated with the distributed node, an energy profile of the distributed node (e.g., use of energy by the distributed node in relation to (e.g., mapped to) conditions, time of day, day of week, event, and/or other factor), location of the distributed node, coverage area of the distributed node, and/or other characteristic, functionality, or feature of the distributed node. Some of the characteristics associated with the distributed node can relate to some conditions associated with the distributed node (e.g., an example characteristic can be that the distributed node can be located in an area where there can be a large hill located north of the distributed node, wherein such characteristic also can influence or can be a factor that can affect the communication-related conditions associated with the distributed node and can be an environmental condition associated with the distributed node). The distributed node 402 can store the condition-related information, characteristics information, and/or other information (e.g., as some of the data 418 (e.g., collected data, statistical data, and/or other data)) in the data store 414.

At various times, the central node 108, employing the data collector component 302, can receive the respective condition-related information and/or the respective characteristics information from the respective distributed nodes (e.g., 110 (or 402) and/or 112). For instance, the data collector component 302 can receive, obtain, and/or collect condition-related information and/or characteristics information from the distributed node 402. In some embodiments, the distributed node 402, employing the data processor component 408, can process (e.g., pre-process) and/or filter items of condition-related information and/or characteristics information, and/or can derive (e.g., determine or calculate) other condition-related information and/or other characteristics information (e.g., summary information, alert or alarm information, highest value or lowest value associated with a condition, average, median, or other value associated with a condition, or other derived item of information) based at least in part on the results of analyzing the items (e.g., raw items) of condition-related information and/or characteristics information, and can communicate the processed (e.g., raw, processed, filtered, and/or derived) items of condition-related information and/or characteristics information to the central node 108. In some embodiments, the data collector component 302 can store the respective condition-related information and/or the respective characteristics information associated with the respective distributed nodes (e.g., as some of the data 310 (e.g., the collected data)) in the data store 308.

In certain embodiments, the central node 108, employing the data processor component 304, can analyze the respective condition-related information and/or the respective characteristics information associated with the respective distributed nodes (e.g., 110 (or 402) and/or 112). As part of the analysis, the data processor component 304 can determine (e.g., compute or otherwise determine) the statistical variables that can characterize the respective data received (e.g., imported, collected, or obtained) the respective distributed nodes. The data processor component 304 can determine such statistical variables, which can characterize the data, on a per distributed node basis, or on an aggregated basis from multiple or all of the distributed nodes, and/or in shorter or longer time durations. The statistical variables can be utilized as some of the various inputs that can be desired by the data pre-processing functions to facilitate preparing the data for use in the training (e.g., multi-stage training) of AI-based models and/or for other desired uses. In some embodiments, the model manager node 116 (or the data processor component 304 or other component) can determine and/or generate statistics of a centralized aggregated dataset initially derived from data generated by multiple distributed nodes (e.g., 110 and 112), wherein these statistics can represent the overall dataset and/or per-distributed node data, and can provide the metrics that can be desired (e.g., wanted or useful) to generate (e.g., create) training datasets for joint (e.g., multi-node) and/or node-specific training stages for training of AI-based models.

In certain embodiments, based at least in part on the results of such analysis, the data processor component 304 can process (e.g., pre-process), filter, segment, or select respective items of condition-related information and/or characteristics information associated with the respective distributed nodes to facilitate determining and generating one or more groups (e.g., datasets) of training data that can be utilized to facilitate training AI-based models. As part of the analysis, the data processor component 304 can try to identify any similarities in the respective condition-related information and/or respective characteristics information associated with the respective distributed nodes. In some embodiments, the data processor component 304 can perform such data processing based at least in part on predetermined (e.g., pre-computed) inputs (e.g., input parameters) and/or configurable input parameters, wherein the respective input and configurable parameters can be customized (e.g., tuned, enhanced, or optimized) for the generation of multi-node training datasets (e.g., the first groups of training data). For instance, based at least in part on first predetermined input parameters and/or first configurable input parameters, and based at least in part on the analysis results, the data processor component 304 can process (e.g., pre-process), filter, segment, or select respective items of condition-related information and/or characteristics information associated with the respective distributed nodes to generate one or more respective first groups of training data (e.g., one or more groups of multi-node training data) that can be utilized to facilitate performing multi-node training of one or more AI-based models (e.g., as part of a first stage of multi-stage model training). In some embodiments, the one or more respective first groups of training data can be tailored or focused on similarities in the respective condition-related information and/or respective characteristics information associated with the respective distributed nodes, as identified (e.g., detected) by the data processor component 304 based at least in part on the analysis results. In certain embodiments, in connection with generating the training data, the data processor component 304 can execute data transformations and/or determine parameters relating to the training data, in accordance with the defined model management criteria, to achieve desired optimization goals. The data processor component 304 can store the one or more respective first groups of training data (e.g., as the training data 312) in the data store 308 for use, if and when desired.

In some embodiments, the respective first groups of training data can relate to respective subgroups of conditions and/or respective subgroups of characteristics. For example, based at least in part on the first predetermined input parameters and/or the first configurable input parameters, and based at least in part on the analysis results, the data processor component 304 can process the data to generate a first group of training data that can relate to a first subgroup of conditions where the distributed nodes can be associated with a relatively high number (e.g., volume) of devices (e.g., distributed nodes near a busy business district where many users can be using devices), a second group (e.g., a different first or multi-node group) of training data that can relate to a second subgroup of conditions where the distributed nodes can be associated with a relatively lower number of devices (e.g., distributed nodes near a business district(s) at night or on weekends where a relatively lower number users can be using devices; or distributed nodes near a rural area where a relatively lower number users can be using devices), and/or another group of training data that can relate to another subgroup of conditions associated with the respective distributed nodes.

In certain embodiments, based at least in part on second predetermined input parameters and/or second configurable input parameters, and based at least in part on the analysis results, the data processor component 304 can process (e.g., pre-process), filter, segment, or select respective items of condition-related information and/or characteristics information associated with a particular distributed node (e.g., distributed node 110 (or 402) or distributed node 112) to generate one or more respective second groups of training data (e.g., one or more groups of node-specific training data) that can be utilized to facilitate performing node-specific training of one or more trained AI-based models (e.g., as part of a second stage of multi-stage model training by the distributed training nodes 120 and/or 122). wherein the respective second input parameters and respective second configurable parameters can be customized (e.g., tuned, enhanced, or optimized) for the generation of node-specific training datasets (e.g., the second groups of training data). In some embodiments, the respective second groups of training data can relate to respective subgroups of conditions and/or respective subgroups of characteristics associated with the particular distributed node. In certain embodiments, statistics relating to or representative of the node-specific data (e.g., relating to the particular distributed node), which can be utilized to determine and generate the second group of training data for node-specific training of the particular distributed node, can be different (or partially similar to) the statistics of the training dataset (e.g., the first group of training data) utilized in the multi-node training stage. The data processor component 304 can store the one or more respective second groups of training data (e.g., as the training data 312) in the data store 308 for use, if and when desired.

In some embodiments, the central node 108, employing the data processor component 304 and/or another component of the central node 108, can determine first parameters that can relate to and/or define the first threshold performance level, based at least in part on the results of analyzing the characteristics and/or statistics of the respective data (e.g., the respective condition-related information and/or the respective characteristics information) collected from the respective distributed nodes (e.g., 110 (or 402) and/or 112) of the group (e.g., cluster) of distributed nodes, wherein the first threshold performance level can be or can relate to (e.g., can correspond to or can be based at least in part on) the expected model precision that can be desired (e.g., wanted or needed) to be attained during the first stage model training (e.g., by the central training node 114). In certain embodiments, since the respective quality of the respective data collected from the respective distributed nodes can vary from distributed node to distributed node and/or over various times, the data processor component 304 can determine (e.g., automatically determine) an input parameter(s) that can be utilized for (e.g., applied to) the threshold performance level determination (e.g., threshold computation) to define the respective weights (e.g., respective weight values) that can be attributed or applied to the respective statistical characteristics of the respective data collected from the respective distributed nodes, in accordance with the defined model management criteria. Accordingly, in certain embodiments, the central node 108, employing the data processor component 304 and/or another component of the central node 108, can determine the first parameters that can relate to and/or define the first threshold performance level, based at least in part on the results of analyzing the characteristics and/or statistics of the respective data collected from the respective distributed nodes, as such characteristics and/or statistics of the respective data are respectively weighted based at least in part on the respective weights. The data processor component 304 can store information (e.g., parameters, hyperparameters, other metadata, and/or other information) relating to the first threshold performance level in the data store 308 and/or can provide such information to the model manager node 116, wherein the model manager node 116 can include such information in a model training request to enable the central training node 114 to know, determine, and/or apply the first threshold performance level and/or corresponding parameters during the first stage of model training of an AI-based model. It is noted that the first threshold performance level can be different at different times depending in part on various factors, including the quality of the collected data, the desired performance target for model training, the type of model, and/or another factor(s).

In some embodiments, with regard to the second stage (e.g., node-specific) model training, the data processor component 304 can estimate, predict, and/or determine an amount of improvement in performance of the trained AI-based model that can be achieved during the second stage, node-specific training of the trained AI-based model, and/or can determine the second threshold level of performance to utilize during the second stage, node-specific training of the trained AI-based model, based at least in part on the results of evaluating (e.g., comparing) the statistics of the node-specific training datasets (e.g., the second groups of training data) and the statistics of the multi-node training datasets (e.g., the first groups of training data). In certain embodiments, the statistics (e.g., statistical data) can comprise or can relate to validation of the performance of each distributed node with respect to the two types of models (e.g., multi-node trained AI-based model versus refined (e.g., node-specific) trained AI-based model), and the measured performance, for each or either of the AI-based models, of the distributed node with respect to the desired outcome or target performance goal, as such goal can be indicated or specified in the defined model management criteria (e.g., performance criteria of the defined model management criteria). In some embodiments, the statistics can relate to the variance in the data of the trained AI-based model using multiple distributed nodes versus the costs (e.g., energy, time, complexity, and/or other cost) associated with the second (e.g., node-specific) model training stage for further model training to generate a refined trained AI-based model with respect to the distributed node, as such costs can be indicated or specified in the defined model management criteria. In still other embodiments, the statistics can involve taking the input data that can be obtained or collected by the distributed node 402 at a rate on the order of that of the symbol rate, and processing (e.g., by the data processor component 408 of the distributed node 402) the data to determine and generate statistical data that can be representative of the collected data, but desirably can be less complex data and/or a lower amount of data than the collected data, wherein the distributed node can transfer such statistical data to the central node (e.g., instead of communicating the higher amount of collected data). Such generation of statistical data, which can be less complex and/or a lower amount of data than the collected data, can be desirable and/or utilized, for example, when the verbose data (e.g., the larger amount of collected data) can be shown, over time, to be no better source for generating training data for model training than the statistical data representative of that same verbose data, without transferring all of that collected data off-node from the distributed node to the central node, which desirably can make the data curation and management less complex and less costly (e.g., less costly with regard to resource usage, time usage, and/or energy usage).

Based at least in part on the amount of improvement in performance of the trained AI-based model that can be achieved during the second model training stage, the data processor component 304 can determine input parameters that can relate to and/or define the second threshold performance level, wherein the second threshold performance level can be or can relate to (e.g., can correspond to or can be based at least in part on) the expected model precision that can be desired (e.g., wanted or needed) to be attained during the second stage model training (e.g., by the distributed training node(s) 120 and/or 122). In certain embodiments, the data processor component 304 can manage (e.g., control, modify, or adjust) these parameters (e.g., from the initial parameter determination based on the amount of improvement in performance) on a per distributed node basis, depending in part on the desired first threshold performance level(s) defined for the joint model training (e.g., the first stage or multi-node model training) and/or the particular distributed node. The data processor component 304 can store information (e.g., parameters, hyperparameters, other metadata, and/or other information) relating to the second threshold performance level in the data store 308 and/or can provide such information to the model manager node 116, wherein the model manager node 116 can include such information in a model training request to enable the distributed training node(s) (e.g., 120 and/or 122) to know, determine, and/or apply the second threshold performance level and/or corresponding parameters during the second stage of model training of a trained (e.g., multi-node trained) AI-based model(s). It is noted that the second threshold performance level can be different at different times depending in part on various factors, including the quality of the collected data, the desired performance target for model training (e.g., second stage model training), the type of model, the particular distributed node, and/or another factor(s).

The system 100 (e.g., employing the central node 108 and distributed training nodes), by employing the enhanced techniques and enhanced model management algorithms described herein, can desirably (e.g., automatically, suitably, efficiently, enhancedly, or optimally) achieve (and its goals and advantages can include), for each distributed node (e.g., distributed node 110 (or 402) and/or distributed node 112), a respective refined (e.g., adapted, customized, and/or node-specific) trained AI-based model (e.g., after performance of the distributed model training) that can have a desirably higher performance than the relatively lower (e.g., minimum) defined performance of generic or multi-node trained AI-based models, wherein the execution of the AI-based algorithms and processes based on the respective refined trained AI-based models can utilize relatively light-weight operations, can be resource-wise (e.g., can utilize less or minimum computational, time, and/or other resources), and can have reduced energy consumption, as compared to the generic or multi-node trained AI-based models. The system 100 (e.g., employing the central node 108 and distributed training nodes), by employing the enhanced techniques and enhanced model management algorithms described herein, also can desirably (e.g., automatically, suitably, efficiently, enhancedly, or optimally) enhance (e.g., improve, maximize, or optimize) the average AI-based model performance across all of the distributed nodes (e.g., 110 (or 402) and/or 112), and can enhance the overall training load for all nodes (e.g., central node 108 and its constituent nodes, the distributed training nodes, and the distributed nodes) and both stages of model training (e.g., as further goals and advantages of the system 100). The system 100, by employing the enhanced techniques and enhanced model management algorithms described herein, can desirably customize the model performance targeted (e.g., can customize and optimize the threshold performance level) at the joint (e.g., multi-node) training stage to the training datasets created from the data collected from the distributed nodes, instead of, for example, merely using a preconfigured threshold performance level, and such customization of the threshold performance levels can allow the system 100 to further enhance (e.g., improve or optimize) the separation between the joint model training (e.g., by the central training node) and distributed model training (e.g., by the distributed training nodes), which can provide additional gains (e.g., additional improvements) for both the joint model training and the distributed model training in the multi-stage training of AI-based models.

In certain embodiments, the central node 108, employing the model manager node 116, can manage (e.g., control and/or coordinate) the training of one or more AI-based models based at least in part on the one or more groups of training data (e.g., the one or more first groups of training data for multi-node training, and/or the one or more second groups of training data for node-specific training), respective groups of parameters and/or hyperparameters, and/or respective threshold performance levels, in accordance with the defined model management criteria. The model manager node 116 can manage and coordinate initiation of the respective model training stages (e.g., first stage, multi-node training stage, and second stage, node-specific training stage), transfer or facilitate transfer of respective training datasets and the model artifacts or metadata to the respective training nodes (e.g., central training node or desired distributed training node(s)). In some embodiments, to facilitate managing such model training, the model manager node 116 can determine and generate one or more mappings of respective groups of training data, respective groups of parameters and/or hyperparameters, and/or other respective model training-related items of information to respective groups of distributed nodes (e.g., where there can be one or more clusters of distributed nodes associated with the central node 108). For instance, the model manager node 116 can determine and generate one or more first mappings of one or more respective first groups of training data (and/or one or more respective groups of parameters and/or hyperparameters, and/or one or more other respective model training-related items of information) to a first group of distributed nodes, one or more second mappings of one or more respective second groups of training data (and/or one or more respective other groups of parameters and/or hyperparameters, and/or one or more other respective model training-related items of information) to a second group of distributed nodes, and/or one or more other mappings of one or more respective other groups of training data (and/or one or more respective other groups of parameters and/or hyperparameters, and/or one or more other respective model training-related items of information) to another group of distributed nodes, to facilitate training (e.g., multi-node training) of respective AI-based models for the respective groups of distributed nodes using respective training data that can be desirable (e.g., useful, wanted, suitable, relevant, enhanced, or optimal) for training of the respective AI-based models.

In certain embodiments, to facilitate managing such model training, the model manager node 116 can generate model training requests that can be communicated to the central training node 114 (e.g., for first stage or multi-node model training) and/or the distributed node (e.g., distributed node 110 (or 402) or 112, for second stage or node-specific model training) to initiate and manage the desired model training. In some embodiments, a model training request can comprise instructions for training a desired trained AI-based model, can indicate or specify the desired trained AI-based model (e.g., stored in the model repository 118) that is to undergo second stage (e.g., node-specific) model training, can indicate or specify the group of training data, or can comprise the group of training data, can indicate or can comprise the group of parameters and/or hyperparameters, can indicate the threshold performance level, and/or can comprise information (e.g., metadata (e.g., characteristic training dataset information and/or other metadata)) relating thereto, that can be utilized to facilitate training of an AI-based model (e.g., by the central training node 114 for the first model training stage, or a distributed node for the second model training stage). If the model training request does not include the group of training data or other model training-related information, the central training node 114 can access and retrieve the group of training data or the other model training-related information from the data store 308, based at least in part on training data-related information (e.g., mapping or other information) contained in the model training request.

In accordance with various embodiments, and in accordance with and/or in response to one or more model training requests, the central training node 114 can train one or more respective AI-based models (e.g., the AI-based model specified in the model training request), based at least in part on application (e.g., input) of one or more respective groups of training data to the one or more respective AI-based models, to generate one or more respective trained AI-based models, in accordance with the defined model management criteria. In some embodiments, as part of a first stage of model training, the central training node 114 can apply (e.g., input) a first group of training data and a first subgroup (of a first group) of parameters and/or hyperparameters to an AI-based model to facilitate training (e.g., multi-node training) the AI-based model. Based at least in part on the application of the first group of training data and the first subgroup of parameters and/or hyperparameters to the AI-based model, the central training node 114 can train the AI-based model to generate a trained AI-based model, in accordance with the defined model management criteria.

In certain embodiments, after an iteration of training of the AI-based model, the central training node 114 can evaluate and/or determine whether the trained AI-based model satisfies (e.g., meets or exceeds; or is at or greater than) a first threshold performance level relating to generating AI-based output result data (e.g., a first performance level relating to accuracy and/or other performance metrics of inferences, probabilities, and/or other AI-based output result data), in accordance with the defined model management criteria. In some embodiments, to facilitate such training evaluation, the central training node 114 can utilize a validation dataset, which can be or can comprise a portion of the first group of training data, to evaluate (e.g., compare against or otherwise evaluate) the performance of the trained AI-based model to determine whether such performance by the trained AI-based model satisfies the first threshold performance level. In certain embodiments, as described herein, the first threshold performance level employed during the first model training stage can be a relatively lower threshold performance level than the second threshold performance level that can be employed during the second model training stage (e.g., by the distributed training node 120), which can desirably reduce the processing load and the amount of resources used to train the AI-based model to generate the trained AI-based model during the first model training stage, although, in other embodiments, if and as desired the first threshold performance level can be the same as the second threshold performance level. Accordingly, in some embodiments, the parameters and/or hyperparameters employed during the first model training stage can be tuned (e.g., tuned, adjusted, or tailored by the central training node 114) to facilitate desirable first stage (e.g., multi-node) model training of the AI-based model to generate the trained AI-based model that can satisfy the first threshold performance level, such as described herein.

If the central training node 114 determines that the trained AI-based model satisfies the first threshold performance level, the central training node 114 can determine that the trained AI-based model is desirably (e.g., suitably, sufficiently, or optimally) trained at this first model training stage, and can discontinue further training of the trained AI-based model. If, instead, the central training node 114 determines that the trained AI-based model does not satisfy the first threshold performance level after the iteration of model training, the central training node 114 can determine that a next iteration of model training can be performed to further train the trained AI-based model to work towards having the trained AI-based model achieve the desired first threshold performance level. In certain embodiments, during the next model training iteration, to facilitate improving performance of the trained AI-based model, the central training node 114 can adjust (e.g., tune) or otherwise manage the respective hyperparameters and/or respective parameters of the parameter group (e.g., can employ a different subgroup of the first group of parameters and/or hyperparameters) and/or can utilize the same first group of training data or a different group (e.g., a different first group) of training data (e.g., although the parameters relating to the first threshold performance level typically can remain the same). The central training node 114 can apply the respective adjusted hyperparameters and/or respective adjusted parameters, and the applicable first group of training data, to the trained AI-based model to continue training of the trained AI-based model. In some embodiments, the central training node 114 can continue performing iterations of model training to train the trained AI-based model, including making appropriate adjustments to the respective hyperparameters and/or respective parameters, and/or to the training dataset, and including evaluating performance of the trained AI-based model after each model training iteration, until the central training node 114 determines that the first threshold performance level is satisfied, or, if still not satisfied, until a defined model training suspension criterion (e.g., a defined maximum number of model training iterations) is determined to be satisfied (e.g., met, reached, or breached). In certain embodiments, after the central training node 114 determines that the trained AI-based model has attained a first performance level that satisfies the first threshold performance level, the central training node 114 can discontinue training of the trained AI-based model, and can store the trained AI-based model, and information (e.g., metadata) relating thereto, in the model repository 118.

In some embodiments, the central training node 114 can similarly train (e.g., perform multi-node training of) one or more other AI-based models, based at least in part on one or more respective first groups of training data, one or more respective first groups of parameters and/or hyperparameters, and/or other model training-related information, to generate one or more other trained AI-based models (e.g., trained model variants) that can relate to various features (e.g., various respective conditions and/or characteristics) associated with the group of distributed nodes (e.g., for one or more groups of distributed nodes), such as described herein. The central training node 114 can store the one or more trained AI-based models, and respective information (e.g., respective metadata) relating thereto, in the model repository.

In accordance with various embodiments, and in accordance with and/or in response to one or more model training requests, the distributed training node 404 can train one or more respective trained AI-based models, based at least in part on application (e.g., input) of one or more respective groups of training data to the one or more respective trained AI-based models, to generate one or more respective refined trained AI-based models that can be utilized by the distributed node 402 (or another distributed node), in accordance with the defined model management criteria. In some embodiments, the distributed training node 404 can receive a request for model training (e.g., node-specific model training) from the model manager node 116, wherein the model training request can indicate or specify the trained AI-based model that is to utilized for the second stage model training, can indicate or specify the group (e.g., second group) of training data, or can comprise the group of training data, can indicate or can comprise the group (e.g., second group) of parameters and/or hyperparameters, can indicate the second threshold performance level, and/or can comprise information (e.g., metadata (e.g., characteristic training dataset information and/or other metadata) and/or other node-specific information) relating thereto, that can be utilized to facilitate training of a trained AI-based model to generate a refined trained AI-based model, as part of the second stage of model training. In certain embodiments, based at least in part on the model training request, the distributed training node 404 can access or receive the trained AI-based model and associated information (e.g., metadata and/or node-specific information) from the model repository 118. In some embodiments, the distributed training node 404 can access or receive the trained AI-based model and associated information from the model repository 118 via a desired (e.g., suitable or optimal) interface that can communicatively couple (e.g., connect) the distributed training node 404 to the central node 108 (e.g., to the model repository 118 of the central node 108) and can support the transfer of information (e.g., trained AI-based models, training datasets, parameters, hyperparameters, metadata, and/or other information) between the central node 108 and the distributed training node 404. In certain embodiments, the interface can be an open fronthaul management (M)-plane of an O-RAN deployment, although, in other embodiments, the interface can be a different type of suitable interface. In accordance with various embodiments, the distributed training node 404 can receive node-specific information (e.g., condition-related information, characteristics information, and/or other information relating to the distributed node 402) from the distributed node 402 and/or the central node 108.

In some embodiments, based at least in part on the model training request, the distributed training node 404 can apply (e.g., input) a second group of training data and a second subgroup (of a second group) of parameters and/or hyperparameters to the trained AI-based model to facilitate training (e.g., refining or further training, and/or performing node-specific training of) the trained AI-based model. Based at least in part on the application of the second group of training data and the second subgroup of parameters and/or hyperparameters to the trained AI-based model, the distributed training node 404 can train the trained AI-based model to generate, or to progress towards generating, a refined trained AI-based model associated with the distributed node 402, in accordance with the defined model management criteria.

In some embodiments, after an iteration of second-stage training of the trained AI-based model, the distributed training node 404 can evaluate and/or determine whether the trained AI-based model satisfies (e.g., meets or exceeds; or is at or greater than) the second threshold performance level relating to generating AI-based output result data (e.g., a second performance level relating to accuracy and/or other performance metrics of inferences, probabilities, and/or other AI-based output result data), in accordance with the defined model management criteria. In some embodiments, to facilitate such training evaluation, the distributed training node 404 can utilize a validation dataset, which can be or can comprise a portion of the second group of training data, to evaluate (e.g., compare against or otherwise evaluate) the performance of the trained AI-based model (e.g., the refined or further trained AI-based model) to determine whether such performance by the trained AI-based model satisfies the second threshold performance level. In certain embodiments, the second threshold performance level employed during the second model training stage typically can be a relatively higher threshold performance level than the first threshold performance level that can be employed during the first model training stage (e.g., by the central training node 114), such as described herein. Accordingly, in some embodiments, the parameters and/or hyperparameters employed during the second model training stage can be tuned (e.g., tuned, adjusted, or tailored by the distributed training node 404 and/or model manager node 116) to facilitate desirable second stage (e.g., node-specific) model training of the trained AI-based model to generate the refined trained AI-based model that can satisfy the second threshold performance level, such as described herein.

In certain embodiments, if the distributed training node 404 determines that the refined trained AI-based model satisfies the second threshold performance level, the distributed training node 404 can determine that the refined trained AI-based model is desirably (e.g., suitably, sufficiently, enhancedly, or optimally) trained, and can discontinue further training of the refined trained AI-based model. In some embodiments, if, instead, the distributed training node 404 determines that the trained (e.g., further trained) AI-based model does not satisfy the second threshold performance level after the iteration of model training, the distributed training node 404 can determine that a next iteration of second stage model training can be performed to further train the trained AI-based model to work towards having the trained AI-based model becoming the refined trained AI-based model that can achieve the desired second threshold performance level. In certain embodiments, during the next second stage model training iteration, to facilitate improving performance of the trained AI-based model, the distributed training node 404 can adjust (e.g., tune) or otherwise manage the respective hyperparameters and/or respective parameters of the parameter group (e.g., can employ a different subgroup of the second group of parameters and/or hyperparameters) and/or can utilize the same second group of training data or a different group (e.g., a different second group) of training data (although the parameters relating to the second threshold performance level typically can remain the same). The distributed training node 404 can apply the respective adjusted hyperparameters and/or respective adjusted parameters, and the applicable second group of training data, to the trained AI-based model to continue training of the trained AI-based model.

In some embodiments, the distributed training node 404 can continue performing iterations of second stage model training to train the trained AI-based model, including making appropriate adjustments to the respective hyperparameters and/or respective parameters, and/or to the training dataset, and including evaluating performance of the trained AI-based model after each model training iteration, until the distributed training node 404 determines that the second threshold performance level is satisfied, or, if still not satisfied, until a defined model training suspension criterion (e.g., a defined maximum number of second stage model training iterations) is determined to be satisfied. In certain embodiments, after the distributed training node 404 determines that the trained AI-based model is the refined trained AI-based model that has attained a second performance level that satisfies the second threshold performance level, the distributed training node 404 can discontinue training of the refined trained AI-based model, and can store the refined trained AI-based model, and information (e.g., metadata and node-specific information) relating thereto, in the model repository 118 of the central node 108 and/or in the in the local model repository 416 (e.g., as model 420 stored in a model library or repository) of the distributed node 402 (and/or in the data store of the distributed training node 404). In some embodiments, as a result of the second stage (e.g., node-specific) model training, the refined trained AI-based model can be tailored (e.g., customized or adapted) to account for the particular or unique conditions and characteristics associated with the distributed node 402 in connection with the refined trained AI-based model generating AI-based output result data, such that the AI-based output result data relating to the distributed node 402 generated by the refined trained AI-based model can be enhanced, as compared to other AI-based output result data relating to the distributed node 402 that otherwise may have been generated by a generic or multi-node trained AI-based model, and such that the execution of the AI-based processing function (e.g., AI-based optimization algorithm) based on the refined trained AI-based model can utilize relatively light-weight operations, can be resource-wise (e.g., can utilize less, fewer, or minimum computational, time, and/or other resources), and can have reduced (e.g., minimized or lower) energy consumption, as compared to the generic or multi-node trained AI-based model.

In some embodiments, the distributed training node 404 can similarly train (e.g., perform node-specific training of) one or more other trained AI-based models, based at least in part on one or more respective second groups of training data, one or more respective second groups of parameters and/or hyperparameters, and/or other model training-related information, to generate one or more other refined trained AI-based models (e.g., trained model variants) that can relate to various features (e.g., various respective conditions and/or characteristics) associated with the distributed node 402, such as described herein. For instance, the distributed training node 404 can train a first refined trained AI-based model (e.g., a first variant of a refined trained AI-based model) that can be utilized by the distributed node 402 when the distributed node 402 is experiencing a first set of conditions (e.g., a first (e.g., higher) level of distributed node or network congestion, a first time period (e.g., business hours on a workday in a business district), and/or conditions relating to a first event), and/or has a first set of characteristics, can train a second refined trained AI-based model (e.g., a second variant of a refined trained AI-based model) that can be utilized by the distributed node 402 when the distributed node 402 is experiencing a second set of conditions (e.g., a second (e.g., lower) level of distributed node or network congestion, a second time period (e.g., nighttime hours or weekend hours in a business district with most businesses closed at night or on weekends), and/or conditions relating to a second event) and/or has a second set of characteristics, and/or can train another refined trained AI-based model (e.g., another variant of a refined trained AI-based model) that can be utilized by the distributed node 402 when the distributed node 402 is experiencing another set of conditions and/or has another set of characteristics, in accordance with the defined model management criteria (e.g., defined model selection criteria of the defined model management criteria). The distributed training node 404 can store the one or more refined trained AI-based models in the model repository 118 of the central node 108 and/or in the local model repository 416 of the distributed node 402 (and/or in the data store of the distributed training node 404).

With further regard to the second group(s) of training data that can be utilized for second stage model training, while, in some embodiments, the distributed training node 404 can receive the second group(s) of training data from the central node 108, in accordance with various embodiments, the distributed training node 404 (e.g., employing the data processor component 408 or its own data processor component) can determine and generate a second group of training data, and/or can augment (e.g., modify, update, or adapt) a second group of training data, received from the central node 108, to generate an augmented second group of training data, based at least in part on the results of analyzing, processing, filtering, and/or selecting respective items of condition-related information and/or characteristics information, in a manner that can be the same as or similar to how the data processor component 304 generates second groups of training data, such as described herein. In that regard, it is noted that the distributed node 402 (e.g., employing the data collector component 406) can be receiving or collecting data relating to the conditions and/or characteristics in real time or near real time, and the distributed training node 404 can utilize (e.g., incorporate, analyze, and/or process) this data to determine the respective conditions and/or characteristics associated with the distributed node 402 (e.g., at a given time), and generate a second group of training data and/or augment a received second group of training data to generate an augmented second group of training data.

In accordance with various embodiments, one or more other respective distributed training nodes (e.g., distributed training node 122) associated with one or more other respective distributed nodes (e.g., distributed node 112) can perform second stage model training on respective trained (e.g., multi-node trained) AI-based models to generate respective refined trained AI-based models for use by the respective distributed nodes, in a same or similar manner as described herein with regard to the distributed training node 404 and the distributed node 402. Those other respective refined trained AI-based models, and respective associated model-related information, can be stored in the model repository 118 of the central node 108 and/or in the other respective local model repositories of the other respective distributed nodes (and/or in the other respective data stores of the other respective distributed training nodes).

In accordance with various embodiments, the distributed node 402 can determine and select a desirable refined trained AI-based model from its local model repository 416 or from the model repository 118 of the central node 108, based at least in part on the conditions and/or characteristics associated with the distributed node 402, in accordance with the defined model management criteria. In some embodiments, the distributed node 402, employing the data processor component 408 (e.g., local data analyzer and processor), can analyze data relating to conditions and/or characteristics associated with the distributed node 402 and/or the devices (e.g., 104 and/or 106) associated with the distributed node 402 at a desired time (e.g., over a recent time period, over a current time period, or with regard to anticipated or predicted conditions and/or characteristics over a future time period (e.g., in the near future)). Based at least in part on the results of the analysis of the data, the data processor component 408 or the model selector component 410 can determine the conditions and/or the characteristics associated with the distributed node 402 and/or the devices at the desired time. Based at least in part on the conditions and/or the characteristics associated with the distributed node 402 and/or the devices at the desired time, the model selector component 410 can determine (e.g., identify) a desirable refined trained AI-based model stored in the local model repository 416 (e.g., the local model library or repository of the distributed node 402) or stored in the model repository 118 of the central node 108, in accordance with the defined model management criteria, wherein the desirable refined trained AI-based model can be the desirable (e.g., most suitable or optimal) model for the distributed node 402 to utilize in connection with the desired time (e.g., at that time or a time in the near future), given the conditions and/or the characteristics associated with the distributed node 402 and/or the devices at the desired time. The model selector component 410 can access and/or retrieve the desired refined trained AI-based model from the local model repository 416 of the distributed node 402 or the model repository 118 of the central node 108. Once instantiated by the distributed node 402, the desired (e.g., selected) refined trained AI-based model can determine and generate inferences, probabilities, and/or other AI-based output result data, based at least in part on the results of analyzing (e.g., performing an AI-based analysis on) data (e.g., condition-related data, characteristics data, and/or other data) input to the refined trained AI-based model.

The data processor component 408 can continue to monitor, analyze, and/or determine conditions and/or the characteristics associated with the distributed node 402 and/or the devices at desired times. The model selector component 410 can continue to determine, select, and/or instantiate desirable (e.g., most suitable or optimal) refined trained AI-based models at the desired times, based at least in part on the respective conditions and/or the respective characteristics associated with the distributed node 402 and/or the devices at the respective desired times, in accordance with the defined model management criteria (e.g., the defined model selection criteria of the defined model management criteria).

In certain embodiments, there may be an instance where a refined trained AI-based model associated with another distributed node (e.g., 112), and stored in the model repository 118, can be desirable (e.g., suitable or optimal) for use by the distributed node 402 based at least in part on particular conditions and/or characteristics associated with the distributed node 402 and/or associated devices at a particular time period, where, for example, the distributed node 402 may not yet have a refined trained AI-based model that is as desirable under those particular conditions and/or characteristics. In such an instance, the model selector component 410 can determine that the refined trained AI-based model associated with the other distributed node can be selected for use by the distributed node 402, and the model selector component 410 can access and/or retrieve the desired refined trained AI-based model from the model repository 118 of the central node 108 for use by the distributed node 402.

In certain other instances, a refined trained AI-based model associated with another distributed node (e.g., 112), and stored in the model repository 118, can relate to certain conditions and/or certain characteristics that can be similar to some conditions and/or some characteristics that can be associated with the distributed node 402 at certain times, wherein, for example, the distributed node 402 may not yet have a refined trained AI-based model that can be desirable under those certain conditions and/or certain characteristics. In some embodiments, instead of the distributed training node 404 performing second stage (e.g., node-specific) model training on a first stage trained AI-based model to generate a refined trained AI-based model relating to those certain conditions and/or certain characteristics, the distributed training node 404 performing node-specific (e.g., third stage) model training on the refined trained AI-based model associated with the other distributed node to generate a refined trained AI-based model usable by the distributed node 402 under those certain conditions and/or certain characteristics, in accordance with the defined model management criteria. In such instance, the distributed training node 404 may utilize fewer iterations, processing, and/or resources in adapting the refined trained AI-based model associated with the other distributed node to generate the refined trained AI-based model usable by the distributed node 402 under those certain conditions and/or certain characteristics than the distributed training node 404 may otherwise have used to perform second stage model training on the first stage trained AI-based model to generate a similar refined trained AI-based model for use under those certain conditions and/or certain characteristics.

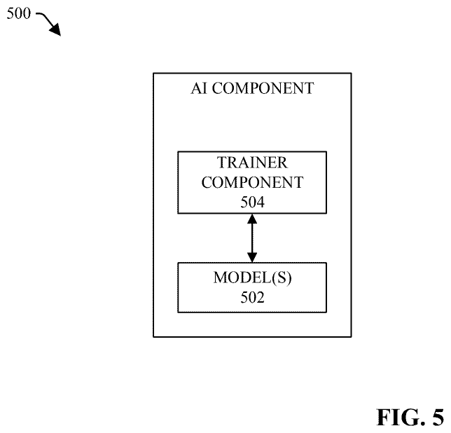

Referring to FIG. 5 (along with FIGS. 1-4), FIG. 5 depicts a diagram of a non-limiting example AI component 500, in accordance with various aspects and embodiments of the disclosed subject matter. In accordance with various embodiments, the central training node 114 or a distributed training node (e.g., 120 (or 402) or 122) can be or can comprise an AI component, such as the AI component 500. In some embodiments, the AI component 500 and/or a model 502 (e.g., AI-based model) can perform an AI-based analysis on data, such as information relating to communication sessions, data traffic, applications, services, attributes, conditions, characteristics, operations, functions, parameters, events, and/or other features associated with the RAN and/or devices (e.g., device 104 and/or device 106), and/or the core network 204, and/or feedback information (e.g., feedback information from a user, a device, a base station, network equipment or network function of the core network 204, or another data source). In some embodiments, with regard to a model 502, the AI component 500 can input such information into the (trained) model 502 for analysis (e.g., AI-based analysis) by the model 502 to train or update the model 502 or to generate AI-based output result data based at least in part on the analysis of the input information.

In connection with or as part of such an AI-based analysis, the AI component 500 can employ, build (e.g., construct or create), and/or import, AI-based techniques and algorithms, AI-based models 502 (e.g., untrained or trained models), neural networks (e.g., untrained or trained neural networks), decision trees, Markov chains (e.g., trained Markov chains), and/or graph mining to render and/or generate predictions, inferences, calculations, prognostications, estimates, derivations, forecasts, detections, and/or computations that can facilitate determining or learning data patterns in data, determining or learning a correlation, relationship, or causation between an item(s) of data and another item(s) of data (e.g., occurrence of the other item(s) of data or an event relating thereto), determining or learning a correlation, relationship, or causation between an event and another event (e.g., occurrence of another event), determining or learning about patterns of communication of data associated with applications, services, and/or devices, determining or learning about patterns of conditions and/or characteristics associated with a distributed node, determining or learning about patterns of respective conditions and/or respective characteristics associated with a group of distributed nodes, determining or learning about similarities or differences between respective conditions and/or respective characteristics associated with respective distributed nodes, determining or learning about data traffic associated with communication sessions between the RAN and devices (e.g., 104 and/or 106), performing other desired functions or operations, and/or automating one or more functions or features of the disclosed subject matter, as more fully described herein.

The AI component 500 can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 500 can examine the entirety or a subset of the data (e.g., the training data; the operational data relating to the communication network 102, the core network 204, a device (e.g., device 104 and/or device 106), the RAN, a base station, one or more distributed nodes, and/or the services; the feedback information; and/or other information, such as described herein) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

In some embodiments, with regard to probabilities, the AI component 500 and/or the trained model(s) 502 can employ one or more threshold probabilities (e.g., threshold probability values) to facilitate making a determination. For instance, in making a determination (e.g., a determination of whether a desired QoS associated with a device associated with a distributed node can be satisfied under certain conditions associated with the distributed node and/or the device, or other determination), as part of the AI-based analysis of information, the AI component 500 and/or the trained model(s) 502 can determine a probability (e.g., a probability that the desired QoS associated with the device can be satisfied under the certain conditions associated with the distributed node and/or the device, or other probability), and can determine whether the probability (e.g., probability value) satisfies (e.g., meets or exceeds; or is at or greater than) a defined and applicable threshold probability. The AI component 500 and/or the trained model(s) 502 can make a determination (or prediction or inference) (e.g., a determination (or prediction or inference) of whether to allocate more resources for the device to satisfy, or try to satisfy, the desired QoS associated with the device, or other determination) based at least in part on the results of analyzing (e.g., comparing) the probability to the defined and applicable threshold probability (e.g., threshold minimum probability value). As a non-limiting example, the AI component 500 and/or the trained model(s) 502 can make a determination (or prediction or inference) that allocating more resources for the device can satisfy the desired QoS associated with the device based at least in part on determining that a probability that allocating more resources for the device can satisfy the desired QoS associated with the device satisfies the defined and applicable threshold probability (e.g., the probability is the highest probability, relative to other probabilities relating to achieving the desired QoS associated with the device, and satisfies the defined and applicable threshold probability). In other embodiments, the AI component 500 and/or the trained model(s) 502 can make a determination (or prediction or inference) that allocating more resources for the device can satisfy the desired QoS associated with the device based at least in part on determining that a probability that allocating more resources for the device can satisfy the desired QoS associated with the device is a highest probability relative to the other probabilities, without use of and/or without regard to a threshold probability.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

In some embodiments, the AI component 500 can employ a classifier that can perform an AI-based analysis on data. A classifier can map an input attribute vector, z=(z1, z2, z3, z4, . . . , zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

In some embodiments, the AI component 500 (e.g., employing the trainer component 504) can comprise, generate, and/or train (e.g., iteratively train) AI-based models 502 that can be trained to learn, determine, predict, or infer data patterns in data; a correlation, relationship, or causation between an item(s) of data and another item(s) of data (e.g., occurrence of the other item(s) of data or an event relating thereto); a correlation, relationship, or causation between an event and another event (e.g., occurrence of another event); relationships between components (e.g., RAN, cells, distributed nodes, network nodes, communication links, devices, or other components or functions) of or associated with the communication network 102; data traffic (e.g., type of data traffic, amount of data traffic, or other characteristic of data traffic) associated with communication sessions between the RAN and devices (e.g., device 104 and/or device 106, utilizing an application or service); patterns of communication of data associated with applications, services, and/or devices; patterns of conditions and/or characteristics associated with a distributed node; patterns of respective conditions and/or respective characteristics associated with a group of distributed nodes; similarities or differences between respective conditions and/or respective characteristics associated with respective distributed nodes; and/or patterns of data traffic associated with communication sessions between devices (e.g., 104 and/or 106) and a distributed node, a group of distributed nodes, and/or the RAN; and/or to perform other desired functions or operations, and/or to automate one or more functions or features of the disclosed subject matter, as described herein.

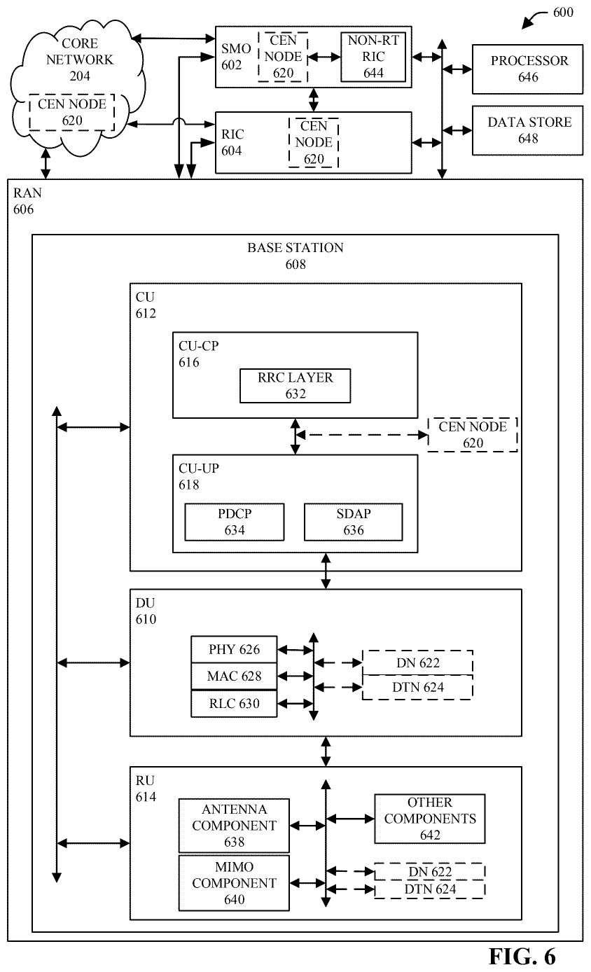

Turning to FIG. 6 (along with FIGS. 1 and 2), FIG. 6 depicts a block diagram of non-limiting example system 600 that can comprise the central node and the distributed training node(s) in the RAN in an O-RAN communication network environment to facilitate desirable (e.g., suitable, reliable, efficient, enhanced, and/or optimal) management and performance of multi-stage training (e.g., multi-node and node-specific training) of AI-based models, in accordance with various aspects and embodiments of the disclosed subject matter. In some embodiments, the system 600 can be part of the system 100 depicted in FIG. 1 or the system 200 depicted in FIG. 2.

The system 600 can comprise an SMO 602, a RIC 604, and a RAN 606. In some embodiments, the RAN 606 can be an O-RAN that can be part of an O-RAN architecture and environment (e.g., the communication network 102 can employ an O-RAN architecture and environment). In certain embodiments, the RAN 606 can be deployed as a centralized or distributed RAN, and, in either of those cases, the RAN 606 can be instantiated on a cloud as a cloud-based RAN (C-RAN), or instantiated on a virtualized infrastructure as a virtual RAN (vRAN), wherein any of these scenarios and implementations may or may not be following O-RAN architecture and specifications. In still other embodiments, the RAN 606 may not be an O-RAN, C-RAN, or vRAN.

In accordance with various embodiments, the RAN 606 and associated communication network (e.g., communication network 102) can be part of a 5G or other communication environment (e.g., an xG communication environment, wherein x can be 5 or a number greater than 5). In some embodiments, with regard to 5G or other generation (e.g., xG), the RAN 606 can comprise base stations, such as a gNodeB (gNB), that can be disaggregated into a CU (e.g., gNB CU), comprising a CU-user plane (CU-UP) (e.g., gNB CU-UP), a CU-control plane (CU-CP) (e.g., gNB CU-CP), and a DU (e.g., gNB DU). In certain embodiments, the CU-UP and DU can perform various desired user plane functions, with the CU-UP hosting PDCP and SDAP functions, and the DU can host the RLC, MAC, and optionally, at least part of the PHY layers. For instance, the RAN 606 can comprise the base station 608 that can comprise a DU 610, a CU 612, and an RU 614 (e.g., a gNB RU). The CU 612 can comprise a CU-CP 616 (also referred to as a CU-CP node) and a CU-UP 618 (also referred to as a CU-UP node). In certain embodiments, the RAN 606 and/or the base station 608 can comprise multiple DUs, multiple CU-CPs, multiple CU-UPs, and/or multiple RUs. In some embodiments, the DU 610, the CU 612, and the RU 614 can be co-located at a cell site. In other embodiments, the RAN 606 can be a disaggregated RAN where one or more of the components (e.g., the CU 612, or at least part of the CU 612, such as the CU-CP 616) of the base station 608 can be located in different location than one or more other components (e.g., DU 610, RU 614, and/or CU-UP 618) of the base station 608.

In accordance with various embodiments, the system 600 can comprise a central node 620 that can be associated with (e.g., communicatively connected to or part of) the SMO 602, the RIC 604, and/or the CU 612, and/or can otherwise be part of or associated with the RAN 606, wherein the central node 620 can comprise various functionality and features, such as described herein. In accordance with various embodiments, the system 600 can comprise one or more distributed nodes, such as distributed node 622 that can be associated with (e.g., communicatively connected to or part of) the RU 614 and/or the DU 610, and/or can otherwise be part of the RAN 606, wherein the one or more distributed nodes (e.g., distributed node 622) can comprise various functionality and features, such as described herein. In accordance with various embodiments, the system 600 also can comprise one or more distributed training nodes, such as distributed training node 624 that can be associated with (e.g., communicatively connected to or part of) the distributed node 622, the RU 614, the DU 610, and/or the CU 612, and/or can otherwise be part of the RAN 606 and/or the central node 620, wherein the one or more distributed training nodes (e.g., distributed training node 624) can comprise various functionality and features, such as described herein. As a non-limiting example, one or more distributed training nodes, such as the distributed training node 624, can be logical distributed training nodes that can be physically or deployment-wise within the CU 612 or CU host, and can be mapped to specific RUs (e.g., RU 614 and/or another RU(s)) and/or DUs (e.g., DU 610 and/or another DU(s)).

The DU 610 can be a logical node that can host or handle baseband (e.g., physical layer (PHY) 626 (e.g., layer 1 (L1))) and layer 2 (L2) (e.g., a medium access control (MAC) layer 628 and a radio link control (RLC) layer 630) functionality associated with the base station 608. The CU-CP 616 can be a logical node that can host or handle layer 3 (L3) (e.g., a radio resource control (RRC) layer 632) control plane functionality associated with the base station 608. The CU-UP 618 can be a logical node that can host or handle data traffic between the core network 204 (e.g., 5G core network) and one or more DUs (e.g., the DU 610) to which the CU-UP 618 is connected. In some embodiments, the CU-UP 618 can comprise a packet data convergence protocol (PDCP) component (PDCP) 634 that can perform PDCP functions, and a service data adaptation protocol (SDAP) component (SDAP) 636 that can perform SDAP functions. In certain embodiments, the PDCP protocol can be utilized as part of the RRC layer 632 to process signaling bearers.

The RU 614 can be or can comprise a logical node that can host a lower PHY layer and radio frequency (RF) processing, where signals (e.g., RF signals) can be transmitted, received, amplified, digitized, or otherwise processed, to facilitate communication of information (e.g., signals comprising information) between the RAN 606 and other devices (e.g., devices 104 and/or 106) or components (e.g., components or functions of the core network 204 or communication network 102). In certain embodiments, depending in part on the fronthaul split (e.g., the division of fronthaul-related functions) utilized, some higher PHY layer functions also can be included and employed in the RU 614. In some embodiments, the RU 614 can comprise an antenna component 638 that can comprise an antenna array that can comprise a desired number of transmitter and receiver antennas to facilitate transmission and receiving of signals comprising information, and perform various beamforming, antenna-related, and communication-related functions. The RU 614 also can comprise a MIMO component 640 that can be employed to generate or modify a number of MIMO spatial layers and a number of spatial streams employed by the base station 608 (e.g., with regard to a device(s)) during a communication session between the base station 608 and a device (e.g., device 104), and may perform MIMO spatial multiplexing functions. In certain embodiments, the MIMO component 640 can be configured in a single user (SU)-type MIMO mode or a multiple user (MU)-type MIMO mode. In some embodiments, the MIMO component 640 can employ or support massive MIMO (mMIMO). The RU 614 also can comprise or be associated with other components 642 that can utilize and/or perform various other RU and RF functions. Some other functions that can be employed by the antenna component 638, the MIMO component 640, and/or the other components 642 can include, for example, modulation and coding scheme (MCS) functions, transmit diversity functions, beamforming functions (e.g., utilized with MIMO functions), and/or other functions.

In some embodiments, as disclosed, the system 600 can comprise an O-RAN architecture and environment, and the RAN 606 can be an O-RAN. In some embodiments, in the O-RAN architecture and environment, the SMO component 602 can be associated with (e.g., communicatively connected to) the RIC 604 and/or the RAN 606 (and/or one or more other RANs) via an interface(s) (e.g., an O1 interface, an A1 interface, or another interface), to facilitate communication of information between the SMO component 602 and the RIC 604 and/or the RAN 606 (and/or one or more other RANs), and the RIC 604 can be associated with the RAN 606 (and/or one or more other RANs) via an interface(s) (e.g., an E2 interface or another interface), to facilitate communication of information between the RIC 604 and the RAN 606 (and/or one or more other RANs). In some embodiments, the SMO component 602 can comprise a non-real time RIC 644 (NON-RT RIC) that can perform some RAN intelligent controller functions in non-real time. In certain embodiments, the RIC 604 can be or can comprise a near real time RIC that can perform at least some of the various RAN intelligent controller functions in real time or at least near real time.

The SMO component 602 can act and operate as a management and orchestration layer that can control configuration and automation aspects of the RIC 604 and RAN elements of the RAN(s) 606. The SMO component 602 can comprise various types of management services and various network functions, comprising network management functions, which can include RAN-type or RAN-related functions, core management functions, transport management functions, network slice management functions (e.g., end-to-end network slice management functions), and/or other network management functions. In accordance with various embodiments, the network functions can be or can comprise physical network functions, virtualized network functions (e.g., virtual machines (VMs), containers, or other virtualized network functions). At least some of the various network functions (e.g., network management functions or other network functions) can operate in real time or near real time.

The RIC 604 can operate to control (e.g., manage) and enhance (e.g., improve or optimize) RAN functions and services of the RAN(s) 606. As disclosed, at least some of the various network functions and components of the RIC 604 can operate in real time or near real time, whereas certain other network functions and components of the non-real time RIC 644 may operate in non-real time.

In accordance with various embodiments, the system 600 can comprise a processor component 646 that can be associated with (e.g., communicatively connected to) and can work in conjunction with other components of the system 600, including the SMO component 602, the RIC 604, the RAN 606, the central node 620, the distributed node 622, the distributed training node 624, a data store 648, and/or other components of the system 600, to facilitate performing the various functions and operations of the system 600. The processor component 646 can employ one or more processors (e.g., one or more central processing units (CPUs)), accelerators, graphics processing units (GPUs), application-specific integrated circuits (ASICs), microprocessors, controllers, microcontrollers, or other processors) that can process information relating to data, files, services, applications, RANs, base stations, cells, communication network, core network, devices, users, data traffic, communication sessions (e.g., PDU or other communication sessions), uplink grants and allocations, condition or measurement reports, conditions, characteristics, the central node, the distributed node(s), the distributed training node(s), AI-based models, multi-node training, node-specific training, AI-related data, training data, feedback information, predictions, inferences, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, the defined model management criteria, algorithms (e.g., enhanced model management algorithms, AI algorithms, hash algorithms, data compression algorithms, data decompression algorithms, and/or other algorithm), interfaces, protocols, tools, and/or other information, to facilitate operation of the system 600, and control data flow between the system 600 and/or other components (e.g., network equipment, components, or functions, the communication network 102, the core network 204, another base station, a device (e.g., 104 or 106), a node, an application, a service, a user, or other entity) associated with the system 600.

The data store 648 can store data structures (e.g., user data, metadata), code structure(s) (e.g., modules, objects, hashes, classes, procedures) or instructions, information relating to data, files, services, applications, RANs, base stations, cells, communication network, core network, devices, users, data traffic, communication sessions, uplink grants and allocations, condition or measurement reports, conditions, characteristics, the central node, the distributed node(s), the distributed training node(s), AI-based models, multi-node training, node-specific training, AI-related data, training data, feedback information, predictions, inferences, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, the defined model management criteria, algorithms (e.g., enhanced model management algorithms, AI algorithms, hash algorithms, data compression algorithms, data decompression algorithms, and/or other algorithm), interfaces, protocols, tools, and/or other information, to facilitate controlling or performing operations associated with the system 600. The data store 648 can comprise volatile and/or non-volatile memory, such as described herein. In an aspect, the processor component 646 can be functionally coupled (e.g., through a memory bus) to the data store 648 in order to store and retrieve information desired to operate and/or confer functionality, at least in part, to the SMO component 602, the RIC 604, the RAN 606, the central node 620, the distributed node 622, the distributed training node 624, the processor component 646, the data store 648, and/or other component of the system 600, and/or substantially any other operational aspects of system 600.

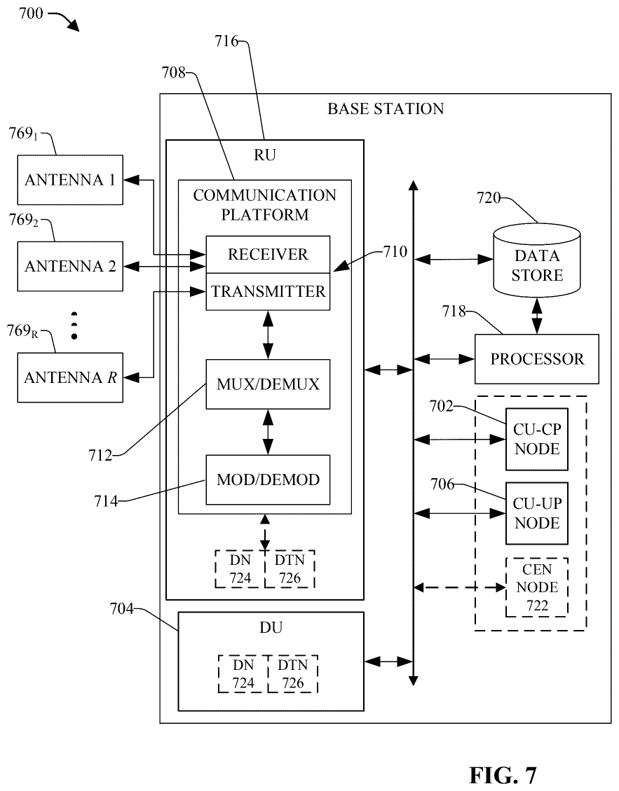

Turning to FIG. 7, FIG. 7 depicts a diagram of a non-limiting example base station 700 that can desirably facilitate (e.g., enable) connections (e.g., wireless connections) and communication of information associated with devices, in accordance with various aspects and embodiments of the disclosed subject matter. In some embodiments, the base station 700 can be a 5G or other radio base station (e.g., gNB or xG base station, wherein x can be a number greater than 5). In other embodiments, the base station 700 can be a 4G or LTE base station, can be a base station that can comprise 5G or other xG functionality and 4G/LTE functionality, or can be some other type of base station (e.g., other type of access point).

With regard to a 5G or other radio base station, the base station 700 can comprise a CU-CP node 702 (e.g., a gNB CU-CP node), one or more DUs (e.g., a gNB DUs), including DU 704, a desired number of CU-UP nodes (e.g., a gNB CU-UP nodes), including CU-UP node 706, and/or other network equipment. The CU-CP node 702 can be associated or interfaced with the DUs (e.g., DU 704) via an interface (e.g., F1-C interface) or connection. The CU-CP node 702 can be associated, or interfaced, with the CU-UP nodes (e.g., CU-UP node 706) via an interface (e.g., E1 interface) or connection. The one or more CU-UP nodes (e.g., CU-UP node 706) can be associated or interfaced with the one or more DUs (e.g., DU 704) via an interface (e.g., F1-U interface) or connection.

A DU (e.g., DU 704) can provide support for lower layers of a protocol stack. For instance, a DU (e.g., DU 704) can be a logical node that can host or handle baseband (e.g., PHY) and L2 (e.g., MAC and RLC layer) functionality associated with the base station 700. A CU-UP node (e.g., CU-UP node 706) can be a logical node that can host or handle data traffic between the core network 204 (e.g., 5G or xG core network) and the DU(s) (e.g., DU 704) to which the particular CU-UP is connected. The CU-CP node 702 can be a logical node that can host or handle L3 (e.g., RRC and PDCP layer) control plane functionality associated with the base station 700.

In some embodiments, a device(s) (e.g., device(s) 110 and/or 112) can be connected to the base station 700, via the DU 704, wherein the CU-UP node 706 and the DU 704 can be serving the device by performing or facilitating performing downlink data transfers of downlink data to the device from a data source (e.g., a service and/or another device, or a network component of the communication network 102 or core network 204 (e.g., via the UPF node)), and uplink data transfers of uplink data from the device to a desired destination (e.g., the data source) via the base station 700.

The base station 700 can receive and transmit signal(s) from and to wireless devices like access points (e.g., base stations, femtocells, picocells, or other type of access point), access terminals (e.g., UEs), wireless ports and routers, and the like, through a set of antennas 769₁-769_{R}. In an aspect, the antennas 769₁-769_{R} can be a part of a communication platform 708, which comprises electronic components and associated circuitry that can provide for processing and manipulation of received signal(s) and signal(s) to be transmitted. In an aspect, the communication platform 708 can include a receiver/transmitter 710 that can convert signal from analog to digital upon reception, and from digital to analog upon transmission. In addition, receiver/transmitter 710 can divide a single data stream into multiple, parallel data streams, or perform the reciprocal operation.

In an aspect, coupled to receiver/transmitter 710 can be a multiplexer/demultiplexer (mux/demux) 712 that can facilitate manipulation of signal in time and frequency space. The mux/demux 712 can multiplex information (e.g., data/traffic and control/signaling) according to various multiplexing schemes such as, for example, time division multiplexing (TDM), frequency division multiplexing (FDM), orthogonal frequency division multiplexing (OFDM), code division multiplexing (CDM), space division multiplexing (SDM), etc. In addition, mux/demux component 712 can scramble and spread information (e.g., codes) according to substantially any code known in the art, e.g., Hadamard-Walsh codes, Baker codes, Kasami codes, polyphase codes, and so on. A modulator/demodulator (mod/demod) 714 also can be part of the communication platform 708, and can modulate information according to multiple modulation techniques, such as frequency modulation, amplitude modulation (e.g., M-ary quadrature amplitude modulation (QAM), with M a positive integer), phase-shift keying (PSK), and the like. In accordance with various embodiments, the communication platform 708 can be, can comprise, or can be associated with an RU 716 (e.g., a gNB RU node).

The base station 700 also can comprise a processor(s) 718 that can be configured to confer and/or facilitate providing functionality, at least partially, to substantially any electronic component in or associated with the base station 700. For instance, the processor(s) 718 can facilitate operations on data (e.g., symbols, bits, or chips) for multiplexing/demultiplexing, modulation/demodulation, such as effecting direct and inverse fast Fourier transforms, selection of modulation rates, selection of data packet formats, inter-packet times, and/or other operations on data.

In another aspect, the base station 700 can include a data store 720 that can store data structures; code instructions; rate coding information; information relating to measurement of radio link quality or reception of information related thereto; information relating to devices, communication conditions or performance indicators associated with devices (e.g., SINR, RSRP, RSRQ, CQI, QoS, perceived QoS, QoE, and/or other wireless communications metrics or parameters) associated with devices; information relating to data, files, services, applications, RANs, cells, communication network, core network, devices, users, data traffic, communication sessions, uplink grants and allocations, condition or measurement reports, conditions, characteristics, the central node, the distributed node(s), the distributed training node(s), AI-based models, multi-node training, node-specific training, AI-related data, training data, feedback information, predictions, inferences, threshold values, weight values, data processing operations, messages, notifications, alarms, alerts, preferences, hash values, metadata, parameters, hyperparameters, traffic flows, tables, mappings, policies, the defined model management criteria, algorithms (e.g., enhanced model management algorithms, AI algorithms, hash algorithms, data compression algorithms, data decompression algorithms, and/or other algorithm), interfaces, protocols, tools, and/or other information; white list information, information relating to managing or maintaining the white list; system or device information like policies and specifications; code sequences for scrambling; spreading and pilot transmission; floor plan configuration; base station deployment and frequency plans; scheduling policies; and so on.

The processor(s) 718 can employ one or more processors (e.g., one or more CPUs, accelerators, GPUs, ASICs, or other processors), microprocessors, or controllers) that can process information, and can be coupled to the data store 720 in order to store and retrieve at least some of the information (e.g., information, such as algorithms, relating to multiplexing/demultiplexing or modulation/demodulation; information relating to radio link levels; information relating to data, files, services, applications, RANs, cells, communication network, core network, devices, users, data traffic, communication sessions, uplink grants and allocations, condition or measurement reports, conditions, characteristics, the central node, the distributed node(s), the distributed training node(s), AI-based models, multi-node training, node-specific training, AI-related data, training data, feedback information, predictions, inferences, threshold values, weight values, data processing operations, messages, notifications, alarms, alerts, preferences, hash values, metadata, parameters, hyperparameters, traffic flows, tables, mappings, policies, the defined model management criteria, algorithms (e.g., enhanced model management algorithms, AI algorithms, hash algorithms, data compression algorithms, data decompression algorithms, and/or other algorithm), interfaces, protocols, tools, and/or other information) desired to operate and/or confer functionality to the communication platform 708 and/or other operational components of the base station 700. The data store 720 can comprise volatile memory and/or nonvolatile memory, such as described herein.

In accordance with various embodiments, the base station 700 can comprise a central node 722 that can be part of or can be associated with (e.g., can be deployed and/or instantiated on the same physical or logical computing infrastructure as or of) the CU (e.g., CU comprising CU-CP node 702 and CU-UP node 706) and/or other components of the RAN, and/or can otherwise be part of or associated with the base station 700, wherein the central node 722 can comprise various functionality and features, such as described herein. In accordance with various embodiments, the base station 700 also can comprise a distributed node 724 and a distributed training node 726 that can be part of or can be associated with the RU 716, the DU 704, and/or other components of the base station 700, and/or can otherwise be part of or associated with the base station 700, wherein the distributed node 724 and the distributed training node 726 can respectively comprise various functionality and features, such as described herein.

With further regard to the data stores and memory disclosed herein, the data store (e.g., 644 or 720) or memory can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects is intended to comprise, without being limited to, these and other suitable types of memory.

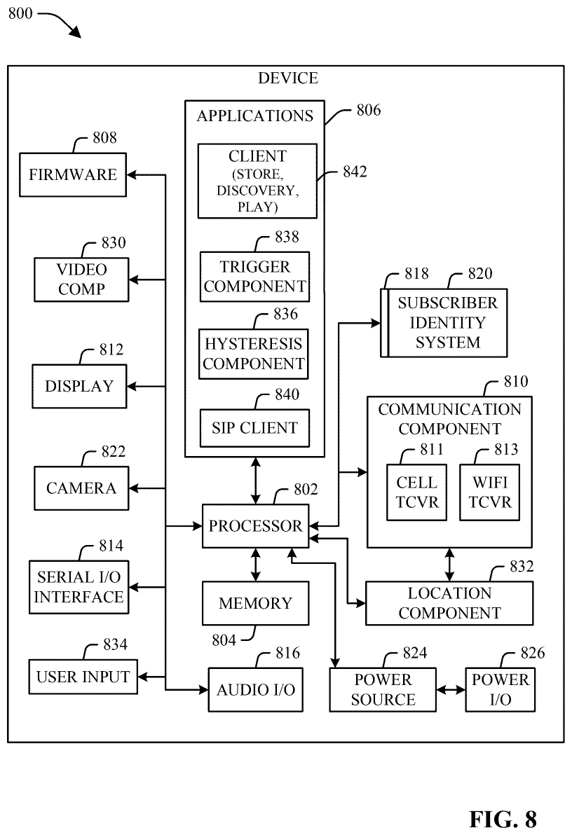

Referring to FIG. 8, FIG. 8 illustrates a diagram of a non-limiting example device 800 (e.g., wireless or mobile phone, electronic pad or tablet, electronic eyewear, electronic watch, other electronic bodywear, IoT device, or other type of communication device or UE) that can be operable to engage in a system architecture that facilitates wireless communications according to one or more embodiments described herein, in accordance with various aspects and embodiments of the disclosed subject matter. Although a device is illustrated herein, it will be understood that other devices can be a communication device, and that the device 800 is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the disclosed subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device, such as the device 800, can typically include a variety of machine-readable media. Machine-readable media can be any available media that can be accessed by the computer and include both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of the any of the above should also be included within the scope of computer-readable media.

The device 800 can include a processor(s) 802 for controlling and processing all onboard operations and functions. The processor(s) 802 can comprise one or more processors (e.g., one or more CPUs, accelerators, GPUs, ASICs, or other processors), microprocessors, or controllers) that can process information associated with the device 800. A memory 804 can interface to the processor(s) 802 for storage of data and one or more applications 806 (e.g., a video player software, user feedback component software, or other application). Other applications can include voice recognition of predetermined voice commands that facilitate initiation of the user feedback signals. Still other applications can comprise an AI application. The applications 806 can be stored in the memory 804 and/or in a firmware 808, and executed by the processor(s) 802 from either or both the memory 804 and/or the firmware 808. The firmware 808 can also store startup code for execution in initializing the device 800. A communication component 810 interfaces to the processor(s) 802 to facilitate wired/wireless communication with external systems, e.g., cellular networks, VoIP networks, and so on. Here, the communication component 810 can also include a suitable cellular transceiver 811 (e.g., a global system for mobile communication (GSM), orthogonal frequency division multiple access (OFDMA), 4G, LTE, 5G, other xG, or other type of transceiver) and/or an unlicensed transceiver 813 (e.g., Wi-Fi, WiMax) for corresponding signal communications. The device 800 can be a device such as a cellular telephone, a PDA with mobile communications capabilities, and messaging-centric devices. The communication component 810 also facilitates communications reception from terrestrial radio networks (e.g., broadcast), digital satellite radio networks, and Internet-based radio services networks.

The device 800 includes a display 812 for displaying text, images, video, telephony functions (e.g., a Caller ID function), setup functions, and for user input. For example, the display 812 can also be referred to as a “screen” that can accommodate the presentation of multimedia content (e.g., music metadata, messages, wallpaper, graphics, etc.). The display 812 can also display videos and can facilitate the generation, editing and sharing of video quotes. A serial I/O interface 814 is provided in communication with the processor(s) 802 to facilitate wired and/or wireless serial communications (e.g., USB, and/or IEEE 1394) through a hardwire connection, and other serial input devices (e.g., a keyboard, keypad, and mouse). This supports updating and troubleshooting the device 800, for example. Audio capabilities are provided with an audio I/O component 816, which can include a speaker for the output of audio signals related to, for example, indication that the user pressed the proper key or key combination to initiate the user feedback signal. The audio I/O component 816 also facilitates the input of audio signals through a microphone to record data and/or telephony voice data, and for inputting voice signals for telephone conversations.

The device 800 can include a slot interface 818 for accommodating a SIC (Subscriber Identity Component) in the form factor of a card Subscriber Identity Module (SIM) or universal SIM 820, and interfacing the SIM card 820 with the processor(s) 802. However, it is to be appreciated that the SIM card 820 can be manufactured into the device 800, and updated by downloading data and software.

The device 800 can process IP data traffic through the communication component 810 to accommodate IP traffic from an IP network such as, for example, the Internet, a corporate intranet, a home network, a person area network, etc., through an ISP or broadband cable provider. Thus, VoIP traffic can be utilized by the device 800 and IP-based multimedia content can be received in either an encoded or a decoded format.

A video processing component 822 (e.g., a camera) can be provided for decoding encoded multimedia content. The video processing component 822 can aid in facilitating the generation, editing, and sharing of video quotes. The device 800 also includes a power source 824 in the form of batteries and/or an AC power subsystem, which power source 824 can interface to an external power system or charging equipment (not shown) by a power I/O component 826.

The device 800 can also include a video component 830 for processing video content received and for recording and transmitting video content. For example, the video component 830 can facilitate the generation, editing and sharing of video quotes. A location tracking component 832 facilitates geographically locating the device 800. As described hereinabove, this can occur when the user initiates the feedback signal automatically or manually. A user input component 834 facilitates the user initiating the quality feedback signal. The user input component 834 can also facilitate the generation, editing and sharing of video quotes. The user input component 834 can include such conventional input device technologies such as a keypad, keyboard, mouse, stylus pen, and/or touch screen, for example.

Referring again to the applications 806, a hysteresis component 836 facilitates the analysis and processing of hysteresis data, which is utilized to determine when to associate with the access point. A software trigger component 838 can be provided that facilitates triggering of the hysteresis component 836 when the Wi-Fi transceiver 813 detects the beacon of the access point. A SIP client 840 enables the device 800 to support SIP protocols and register the subscriber with the SIP registrar server. The applications 806 can also include a client 842 that provides at least the capability of discovery, play and storage of multimedia content, for example, music.

The device 800, as indicated above related to the communication component 810, includes an indoor network radio transceiver 813 (e.g., Wi-Fi transceiver). This function supports the indoor radio link, such as IEEE 802.11, for the dual-mode GSM device (e.g., device 800). The device 800 can accommodate at least satellite radio services through a device (e.g., handset device) that can combine wireless voice and digital radio chipsets into a single device (e.g., single handheld device).

It is to be appreciated and understood that one or more components (e.g., the devices, configuration manager component, base station, core network, or other component) of the systems (e.g., system 100, system 400, system 600, or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

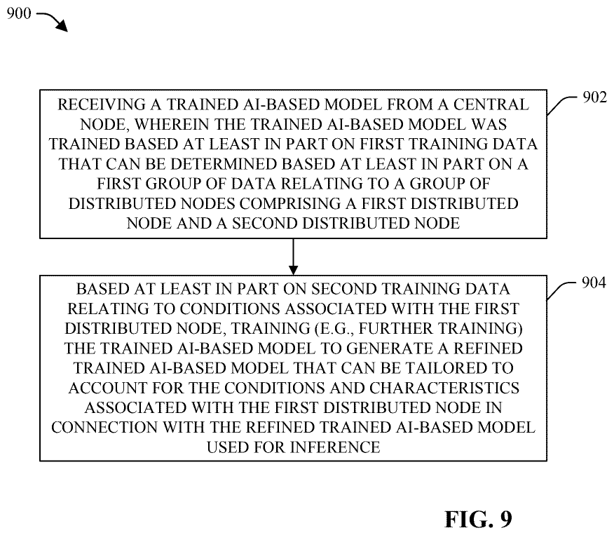

In view of the example systems and/or devices described herein, example methods that can be implemented in accordance with the disclosed subject matter can be further appreciated with reference to flowcharts in FIGS. 9-11. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 9 illustrates a flow chart of an example method 900 that can desirably (e.g., automatically, dynamically, suitably, reliably, efficiently, enhancedly, and/or optimally) manage and perform refined node-specific training of a trained AI-based model initially trained as part of multi-node model training, in accordance with various aspects and embodiments of the disclosed subject matter. The method 900 can be employed by, for example, a system that can comprise the distributed training node (e.g., associated with a first distributed node) that can comprise or be associated with the processor component, the data store, and/or other components.

At 902, a trained AI-based model can be received from a central node, wherein the trained AI-based model was trained based at least in part on first training data that can be determined based at least in part on a first group of data relating to a group of distributed nodes comprising a first distributed node and a second distributed node. In some embodiments, the first distributed training node associated with the first distributed node can receive the trained AI-based model from the central node, which can comprise the training node, such as described herein. In certain embodiments the central training node of the central node can perform a first stage (e.g., a general or multi-node training stage) of model training to train an AI-based model, based at least in part on the first group of data relating to the group of distributed nodes and a first group of parameters and/or hyperparameters, to generate the trained AI-based model.

At 904, based at least in part on second training data relating to conditions associated with the first distributed node, the trained AI-based model can be trained (e.g., further trained) to generate a refined trained AI-based model that can be tailored to account for the conditions and characteristics associated with the first distributed node in connection with the refined trained AI-based model used for inference. In some embodiments, the first distributed training node can perform a second stage (e.g., node-specific training stage) of model training to train the trained AI-based model, based at least in part on the second training data relating to the conditions associated with the first distributed node and a second group of parameters and/or hyperparameters, to generate the refined trained AI-based model that can be tailored to account for the conditions and the characteristics associated with the first distributed node.

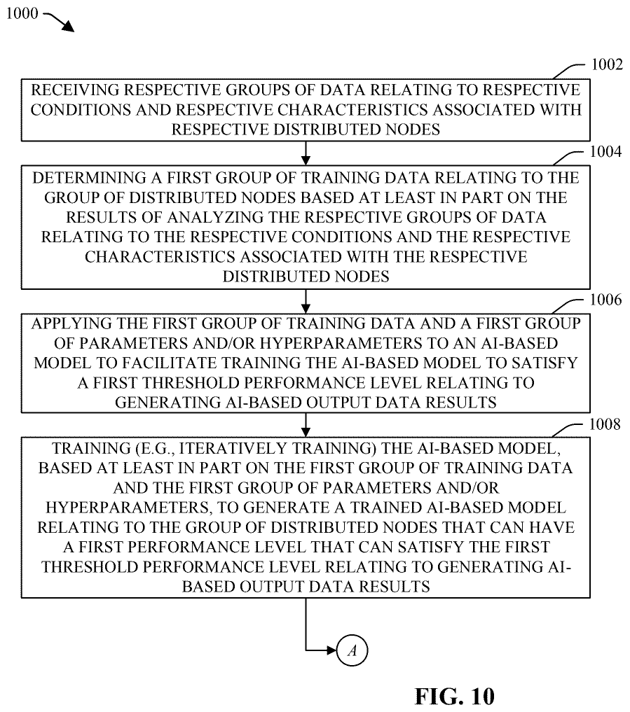

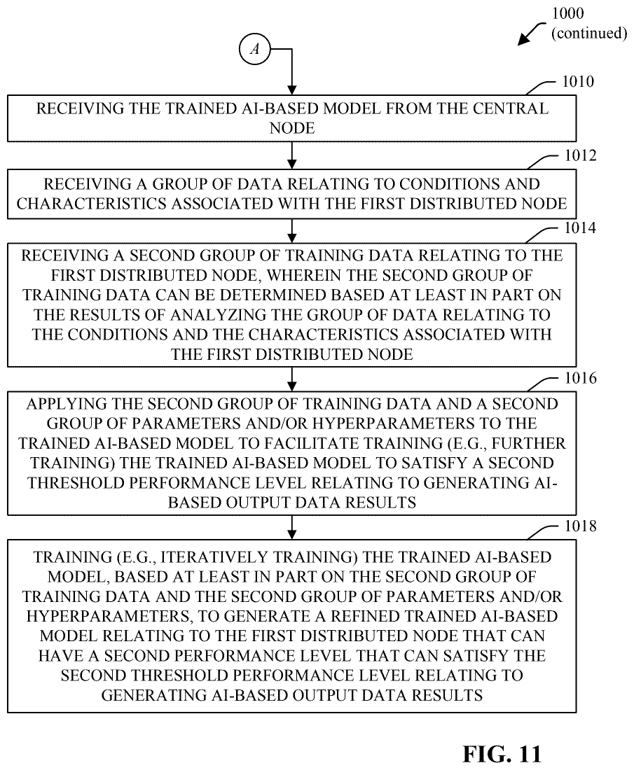

FIGS. 10-11 depict a flow chart of an example method 1000 that can desirably (e.g., automatically, dynamically, suitably, reliably, efficiently, enhancedly, and/or optimally) manage and perform multi-node and node-specific training of an AI-based model, in accordance with various aspects and embodiments of the disclosed subject matter. The method 1000 can be employed by, for example, a system that can comprise the training node (e.g., centralized training node) of the central node and the distributed training node (e.g., associated with a first distributed node and the central node), and also can comprise or be associated with the processor component, the data store, and/or other components.

At 1002, respective groups of data relating to respective conditions and respective characteristics associated with respective distributed nodes can be received. The central node can receive and/or collect the respective groups of data relating to the respective conditions and the respective characteristics associated with the respective distributed nodes, comprising a first distributed node and a second distributed node. In accordance with various embodiments, the respective distributed nodes can be respective RUs, DUs, or other components of a RAN (e.g., a disaggregated RAN). In accordance with various embodiments, the central node, or respective portions thereof, can be part of the core network, or the RAN (e.g., part of the CU, an SMO, a RIC, and/or other component (e.g., another component of the RAN, or a separate component of the RAN).

At 1004, a first group of training data relating to the group of distributed nodes can be determined based at least in part on the results of analyzing the respective groups of data relating to the respective conditions and the respective characteristics associated with the respective distributed nodes. For instance, the central node, employing the data pre-processing node, can process and analyze, which can including filtering and/or segmenting, the respective groups of data, and, based at least in part on the results of such processing, analyzing, filtering, and/or segmenting, the data pre-processing node can determine and generate the first group of training data relating to the group of distributed nodes (e.g., relating to the conditions and characteristics of the group of distributed nodes). In certain embodiments, the first group of training data can be stored in the data store (e.g., the data storage node) of the central node.

At 1006, the first group of training data and a first group of parameters and/or hyperparameters can be applied to an AI-based model to facilitate training the AI-based model to satisfy a first threshold performance level relating to generating AI-based output data results. In some embodiments, the central training node of the central node can apply or input the first group of training data and the first group of parameters and/or hyperparameters to the AI-based model to facilitate training the AI-based model to satisfy the first threshold performance level relating to generating AI-based output data results. In certain embodiments, the data processor component (or the model manager component, the central training node, or other component, or a user) can determine the respective parameters and/or the respective hyperparameters of the first group of parameters and/or hyperparameters based at least in part on the type of AI-based model, the first threshold performance level, and/or other factors, in accordance with the defined model management criteria.

At 1008, the AI-based model can be trained (e.g., iteratively trained), based at least in part on the first group of training data and the first group of parameters and/or hyperparameters, to generate a trained AI-based model relating to the group of distributed nodes that can have a first performance level that can satisfy the first threshold performance level relating to generating AI-based output data results. In some embodiments, as part of a first training stage (e.g., a general or multi-node training stage), the central training node can apply or input the first group of training data to the AI-based model as part of the training of the AI-based model. In certain embodiments, based at least in part on the first group of training data and the first group of parameters and/or hyperparameters, the AI-based model can perform an AI-based analysis on the first group of training data as part of the training of the AI-based model. For instance, the central training node can perform one or more training iterations (e.g., applying respective and/or adjusted parameters and/or hyperparameters to the AI-based model during respective training iterations to facilitate the training) to train (e.g., iteratively and/or incrementally train) the AI-based model. Based at least in part on the results of training the AI-based model, the AI-based model can be trained to generate the trained AI-based model relating to the group of distributed nodes such that the trained AI-based model can have the first performance level that can satisfy the first threshold performance level relating to generating AI-based output data results (e.g., inferences, probabilities, determinations, or other AI-based output data results). In some embodiments, the central training node can store the trained AI-based model in the model repository of the central node, and/or can provide the trained AI-based model to the first distributed training node associated with the first distributed node. At this point, the method 1000 can proceed to reference point A, wherein the method 1000 can continue from reference point A, as depicted in FIG. 11 and described herein.

At 1010, the trained AI-based model can be received from the central node. In some embodiments, the first distributed training node can receive the trained AI-based model from the central node, such as described herein.

At 1012, a group of data relating to conditions and characteristics associated with the first distributed node can be received. In accordance with various embodiments, the first distributed training node can be part of or associated with the first distributed node. In some embodiments, the first distributed training node can receive and/or collect the group of data relating to the conditions and the characteristics associated with the first distributed node of the respective distributed nodes.

At 1014, a second group of training data relating to the first distributed node can be received, wherein the second group of training data can be determined based at least in part on the results of analyzing the group of data relating to the conditions and the characteristics associated with the first distributed node. For instance, the first distributed training node receive the second group of training data from the central node (e.g., as part of the model training request received from the model manager component, or accessed from the data store of the central node based at least in part on training-related information contained in the model training request). In some embodiments, the data processor component of the central node can analyze and process, which can including filtering and/or segmenting, the group of data, and, based at least in part on the results of such analyzing, processing, and filtering, the first distributed training node can determine and generate the second group of training data relating to the first distributed node (e.g., relating to the conditions and characteristics of the first distributed node).

At 1016, the second group of training data and a second group of parameters and/or hyperparameters can be applied to the trained AI-based model to facilitate training (e.g., further training) the trained AI-based model to satisfy a second threshold performance level relating to generating AI-based output data results. In some embodiments, the first distributed training node can apply or input the second group of training data and the second group of parameters and/or hyperparameters to the trained AI-based model to facilitate training (e.g., further training or refining training of) the trained AI-based model to satisfy the second threshold performance level relating to generating AI-based output data results. In certain embodiments, the first distributed training node (or other component or user) can determine the respective parameters and/or the respective hyperparameters of the second group of parameters and/or hyperparameters based at least in part on training-related information contained in the model training request received from the model manager component. In some embodiments, the respective parameters and/or the respective hyperparameters of the second group of parameters and/or hyperparameters can be determined based at least in part on the type of trained AI-based model, the second threshold performance level, and/or other factors, in accordance with the defined model management criteria.

At 1018, the trained AI-based model can be trained (e.g., iteratively trained), based at least in part on the second group of training data and the second group of parameters and/or hyperparameters, to generate a refined trained AI-based model relating to the first distributed node that can have a second performance level that can satisfy the second threshold performance level relating to generating AI-based output data results. In some embodiments, as part of a second training stage (e.g., a node-specific training stage), the first distributed training node can apply or input the second group of training data to the trained AI-based model as part of the further or refined training of the trained AI-based model. In certain embodiments, based at least in part on the second group of training data and the second group of parameters and/or hyperparameters, the trained AI-based model can perform an AI-based analysis on the second group of training data as part of the further or refined training of the trained AI-based model. For instance, the first distributed training node can perform one or more training iterations (e.g., applying respective and/or adjusted parameters and/or hyperparameters to the trained AI-based model during respective training iterations to facilitate the training) to train (e.g., iteratively and/or incrementally train) the trained AI-based model to facilitate generating the refined trained AI-based model. Based at least in part on the results of training the trained AI-based model, the trained AI-based model can be trained (e.g., further trained) to generate the refined trained AI-based model relating to the first distributed node such that the refined trained AI-based model can have the second performance level that can satisfy the second threshold performance level relating to generating AI-based output data results (e.g., inferences, probabilities, determinations, or other AI-based output data results), wherein the second threshold performance level can be higher than the first threshold performance level (and wherein the second performance level can be higher than the first performance level).

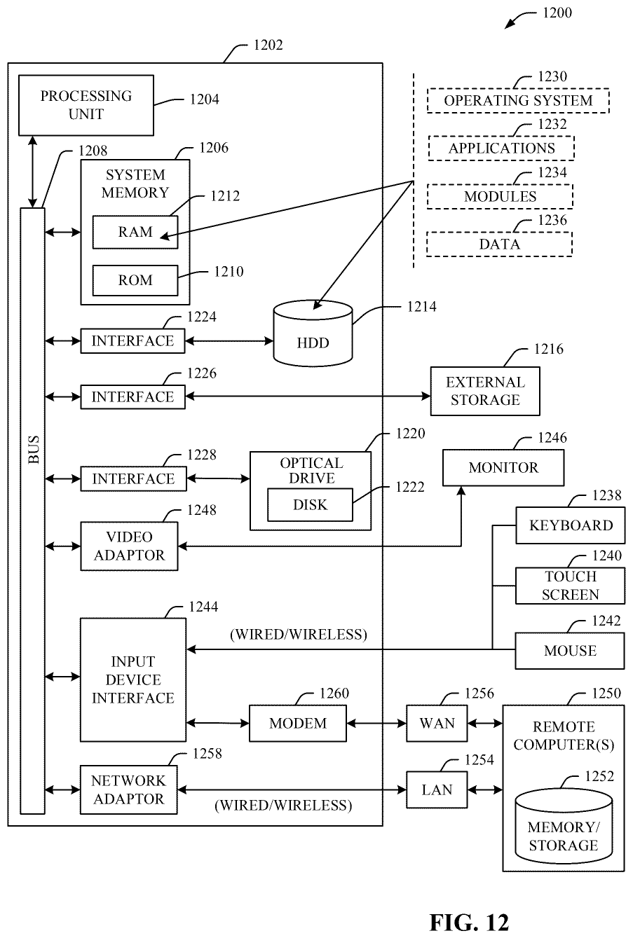

In order to provide additional context for various embodiments described herein, FIG. 12 and the following discussion are intended to provide a brief, general description of a suitable computing environment 1200 in which the various embodiments of the embodiments described herein can be implemented. While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 also can be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can also be connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256, e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), IoT device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., device, UE, communication network, core network, RAN, distributed node, central node, distributed training node, central unit, distributed unit, radio unit, model or AI-based model, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
receiving, by a system comprising at least one processor, a trained artificial intelligence-based model from a central node, wherein the trained artificial intelligence-based model was trained based on first training data that is determined based on a first group of data relating to a group of distributed nodes comprising at least a first distributed node and a second distributed node; and
based on second training data relating to conditions associated with the first distributed node, training, utilizing a distributed training node of the system, the trained artificial intelligence-based model to generate a refined trained artificial intelligence-based model that is tailored to account for the conditions and characteristics associated with the first distributed node in connection with the refined trained artificial intelligence-based model generating an inference.

2. The method of claim 1, wherein an artificial intelligence-based model is trained to generate the trained artificial intelligence-based model, based on the first training data applied to the artificial intelligence-based model and based on a first group of parameter items, comprising first parameters and first hyperparameters, applied during training of the artificial intelligence-based model, to result in the trained artificial intelligence-based model satisfying a first threshold performance level relating to generating first inferences relating to the group of distributed nodes,
wherein the training of the trained artificial intelligence-based model to generate the refined trained artificial intelligence-based model comprises training the trained artificial intelligence-based model to generate the refined trained artificial intelligence-based model based on the second training data applied to the trained artificial intelligence-based model and based on a second group of parameter items, comprising second parameters and second hyperparameters, applied during the training of the trained artificial intelligence-based model, to result in the refined trained artificial intelligence-based model satisfying a second threshold performance level relating to generating second inferences relating to the first distributed node, and wherein the second threshold performance level is higher than the first threshold performance level.

3. The method of claim 1, wherein the refined trained artificial intelligence-based model performs at a second performance level that is higher than a first performance level that the trained artificial intelligence-based model is able to achieve with respect to generating artificial intelligence-based output data relating to the first distributed node, and wherein the first distributed node is, comprises, is part of, or is associated with, a radio unit or a distributed unit of a radio access network, or is part of, or is associated with, a communication network other than a cellular or wireless communication network.

4. The method of claim 1, wherein the refined trained artificial intelligence-based model utilizes fewer resources or less energy than is estimated to be utilized by the trained artificial intelligence-based model with respect to generating artificial intelligence-based output data relating to the first distributed node, and wherein the first distributed node is, comprises, is part of, or is associated with, a radio unit or a distributed unit of a radio access network.

5. The method of claim 1, further comprising:
estimating, by the system, an amount of statistical increase in model performance that is able to be achieved in training the trained artificial intelligence-based model to generate the refined trained artificial intelligence-based model utilizing the second training data based on a result of comparing second statistics relating to the second training data and first statistics relating to the first training data relating to the group of distributed nodes; and
at least one of:
determining, by the system, a threshold performance level relating to generating the inference relating to the first distributed node based on the estimating of the amount of statistical increase in the model performance, wherein the threshold performance level is able to be applied as a performance target during training of the trained artificial intelligence-based model to generate the refined trained artificial intelligence-based model; or
determining, by the system, that the second training data is to be utilized to train the trained artificial intelligence-based model to generate the refined trained artificial intelligence-based model, in response to determining that the amount of statistical increase in the model performance satisfies a defined model training criterion relating to model performance.

6. The method of claim 1, further comprising:
receiving, by the distributed training node, model training instruction data, parameter information relating to parameters or hyperparameters, or metadata from a model manager node, wherein the training of the trained artificial intelligence-based model to generate the refined trained artificial intelligence-based model comprises training, by the distributed training node, the trained artificial intelligence-based model, based on at least one of the second training data, the model training instruction data, the parameter information, or the metadata, to generate the refined trained artificial intelligence-based model.

7. The method of claim 1, further comprising:
communicating, by the distributed training node, the second training data or raw condition-related data relating to the conditions associated with the first distributed node to the central node or a data store associated with the central node for storage in the data store or analysis by a training node of the central node.

8. The method of claim 1, further comprising:
at least one of:
communicating, by the distributed training node, the refined trained artificial intelligence-based model to the central node or a data store associated with the central node for storage in a model repository in the data store; or
communicating, by the distributed training node, the refined trained artificial intelligence-based model to the first distributed node for storage in a local model repository of the first distributed node.

9. The method of claim 1, wherein the conditions comprise operational conditions relating to operation of the first distributed node, communication-related conditions associated with the first distributed node, data traffic and processing load-related conditions, or environmental conditions relating an environment associated with the first distributed node.

10. A system, comprising:
at least one memory that stores computer executable components; and
at least one processor that executes computer executable components stored in the at least one memory, wherein the computer executable components comprise:
a distributed training node that receives a trained artificial intelligence-based model from a central node, wherein the trained artificial intelligence-based model was trained based on first training information that is determined based on a first group of information items relating to a cluster of distributed nodes comprising at least a first distributed node and a second distributed node; and
a model trainer at the distributed training node, wherein the model trainer trains, based on second training information relating to conditions associated with the first distributed node, the trained artificial intelligence-based model to generate a customized trained artificial intelligence-based model that is customized to take into account the conditions and attributes particular to the first distributed node in connection with generation of artificial intelligence-based output information relating to the first distributed node by the customized trained artificial intelligence-based model.

11. The system of claim 10, wherein the artificial intelligence-based output information is second artificial intelligence-based output information, wherein an artificial intelligence-based model is trained to generate the trained artificial intelligence-based model, based on the first training information input to the artificial intelligence-based model and based on a first group of parameter items, comprising first parameters and first hyperparameters, applied during training of the artificial intelligence-based model, to result in the trained artificial intelligence-based model satisfying a first threshold performance value relating to generating first artificial intelligence-based output information relating to the cluster of distributed nodes,
wherein the model trainer trains the trained artificial intelligence-based model to generate the customized trained artificial intelligence-based model based on the second training information input to the trained artificial intelligence-based model and based on a second group of parameter items, comprising second parameters and second hyperparameters, applied during the training of the trained artificial intelligence-based model, to result in the customized trained artificial intelligence-based model satisfying a second threshold performance value relating to generating the second artificial intelligence-based output information relating to the first distributed node, and wherein the second threshold performance value is higher than the first threshold performance value that the trained artificial intelligence-based model is able to attain with respect to generating the second artificial intelligence-based output information relating to the first distributed node.

12. The system of claim 10, wherein the customized trained artificial intelligence-based model performs at a second performance value that is higher than a first performance value that the trained artificial intelligence-based model is able to achieve with respect to generating artificial intelligence-based output information relating to the first distributed node.

13. The system of claim 10, wherein the customized trained artificial intelligence-based model utilizes fewer resources or less energy than is estimated to be utilized by the trained artificial intelligence-based model with respect to generating artificial intelligence-based output information relating to the first distributed node.

14. The system of claim 10, wherein the distributed training node receives, from a model manager node, model training instruction information, parameter information relating to parameters or hyperparameters, or metadata, wherein the model trainer trains the trained artificial intelligence-based model to generate the customized trained artificial intelligence-based model based on the second training information, the model training instruction information, the parameter information, or the metadata, and
wherein the metadata comprises descriptor information that is descriptive of respective characteristics of at least one of the trained artificial intelligence-based model or the customized trained artificial intelligence-based model to facilitate at least one of distributed node-specific training of the trained artificial intelligence-based model to generate the customized trained artificial intelligence-based model, model selection to facilitate determining whether to select the customized trained artificial intelligence-based model for use by the first distributed node, or inference by the customized trained artificial intelligence-based model.

15. The system of claim 10, wherein the distributed training node transmits the second training information or raw condition-related information relating to the conditions associated with the first distributed node to the central node or a data store associated with the central node for storage in the data store or analysis by a training node of the central node, and
wherein the distributed training node transmits the customized trained artificial intelligence-based model to the central node or the data store for storage in a model repository in the data store.

16. The system of claim 10, wherein the distributed training node is a first distributed training node, wherein the first distributed training node of or associated with the first distributed node is in a first physical or logical proximity to the first distributed node that is closer than a second physical or logical proximity of a second distributed training node to the first distributed node and closer than a third physical or logical proximity of the central node to the first distributed node, wherein the second distributed training node is part of or associated with the second distributed node or is part of or associated with central node, and wherein the central node comprises a training node that generated the trained artificial intelligence-based model.

17. The system of claim 10, wherein the first distributed node is, comprises, is part of, or is associated with, a radio unit or a distributed unit of a radio access network, wherein the radio access network is a disaggregated radio access network, and wherein the disaggregated radio access network comprises the distributed unit located in a first location, a central unit located in the first location or a second location, and the radio unit located in the first location, the second location, or a third location.

18. A system, comprising:
at least one memory that stores computer executable components; and
at least one processor that executes computer executable components stored in the at least one memory, wherein the computer executable components comprise:
a trainer node that trains an artificial intelligence-based model, based on first training data applied to the artificial intelligence-based model, to generate a trained artificial intelligence-based model, wherein the first training data is determined based on a first group of data relating to a group of distributed nodes comprising at least a first distributed node and a second distributed node; and
a model repository that stores the trained artificial intelligence-based model, wherein the trainer node or the model repository communicates the trained artificial intelligence-based model to a distributed training node associated with the first distributed node,
wherein the model repository receives, from the distributed training node, an adapted trained artificial intelligence-based model that is adapted to take into account conditions and characteristics unique to the first distributed node in connection with generation of artificial intelligence-based output data relating to the first distributed node by the adapted trained artificial intelligence-based model, and wherein the trained artificial intelligence-based model was trained, based on second training data relating to the conditions, to generate the adapted trained artificial intelligence-based model.

19. The system of claim 18, wherein the artificial intelligence-based output data is second artificial intelligence-based output data, wherein the trainer node trains the artificial intelligence-based model to generate the trained artificial intelligence-based model, based on the first training data input to the artificial intelligence-based model and based on a first group of parameter items, comprising first parameters and first hyperparameters, applied during training of the artificial intelligence-based model, to result in the trained artificial intelligence-based model satisfying a first threshold performance level relating to generation of first artificial intelligence-based output data relating to the group of distributed nodes,
wherein the trained artificial intelligence-based model is trained to generate the adapted trained artificial intelligence-based model based on the second training data input to the trained artificial intelligence-based model and based on a second group of parameter items, comprising second parameters and second hyperparameters, applied during the training of the trained artificial intelligence-based model, to result in the adapted trained artificial intelligence-based model satisfying a second threshold performance level relating to generation of the second artificial intelligence-based output data relating to the first distributed node, and wherein the second threshold performance level is higher than the first threshold performance level that the trained artificial intelligence-based model is able to achieve with respect to generating the second artificial intelligence-based output data relating to the first distributed node.

20. The system of claim 18, wherein the group of data comprises respective subgroups of data received from respective distributed nodes of the group of distributed nodes, wherein the respective subgroups of data are processed and filtered, based on a group of processing parameters, to generate the first training data relating to the group of distributed nodes,
wherein the computer executable components further comprise: a model manager that communicates model training instruction data, parameter data relating to parameters or hyperparameters, or metadata to the trainer node, and
wherein, in response to a model training request received from the model manager, the trainer node trains the artificial intelligence-based model, based on at least one of the first training data, the model training instruction data, the parameter data, or the metadata, to generate the trained artificial intelligence-based model.
